(19) United States
(12) Patent Application Publication
(10) Pub. No.: US 2026/0275812 A1
(43) Pub. Date: Sep. 17, 2026

(54) Methods and Systems for Non-Contact Boring of Tunnels, Shafts, and Trenches

(71) Applicant: Phoenix Boring, Inc., San Francisco, CA (US)

(72) Inventors: Roberto Zillante, San Francisco, CA (US); Thorin Tobiassen, San Francisco, CA (US); Thomas Egan, San Francisco, CA (US); Shivani Torres, San Francisco, CA (US); Ryan Benson, San Francisco, CA (US)

(21) Appl. No.: 19/673,877

(22) Filed: May 11, 2026

Related U.S. Application Data
(63) Continuation of application No. PCT/US24/55736, filed on Nov. 13, 2024.
(60) Provisional application No. 63/598,727, filed on Nov. 14, 2023.
(60) Provisional application No. 63/598,725, filed on Nov. 14, 2023.
(60) Provisional application No. 63/598,721, filed on Nov. 14, 2023.
(60) Provisional application No. 63/598,715, filed on Nov. 14, 2023.

(51) Int. Cl. E21B 7/14; F02C 3/06

(52) U.S. Cl. CPC E21B 7/14; F02C 3/06

(57) ABSTRACT

Described herein are methods and systems for non-contact boring of tunnels, trenches, and/or vertical shafts. A system comprises a chassis, a non-contact boring element, and a boring actuator connecting the non-contact boring element to the chassis and configured to position the non-contact boring element relative to the bore face. These three elements may form an internal subsystem as this subsystem within a tunnel, trench, or shaft. In some examples, a system further comprises an external subsystem, which is positioned away from the tunnel, trench, or shaft. The external subsystem is connected to the internal subsystem using an umbilical cord (e.g., providing power and control signals to the internal subsystem). Furthermore, the system may include an ejecta removal subsystem operationally coupled to the internal and external subsystems. Some examples of a non-contact boring element include a combustor (e.g., a jet turbine, a flame jet) and a plasma torch.

### CROSS-REFERENCE TO RELATED APPLICATIONS

This application is a continuation of PCT/US2024/055736, filed 2024-11-13, which claims the benefit under 35 U.S.C. § 119(e) of US Provisional Patent Application 63/598,715 (filed on 2023-11-14), 63/598,721 (filed on 2023-11-14), 63/598,725 (filed on 2023-11-14), and 63/598,727 (filed on 2023-11-14), all of which are incorporated herein by reference in their entirety for all purposes.

### BACKGROUND

Conventional contact techniques for boring tunnels, trenches, and/or vertical shafts through boulders, solid rocks, and/or transitioning from soil into rocks are slow and require multiple different types of complex and expensive equipment. For example, contact tools (e.g., bore heads) degrade over time due to friction, which can affect the overall process speed, and efficiency, and increase replacement costs. Non-contact methods, on the other hand, do not suffer from tool wear because there’s no direct physical contact with the bore face. Furthermore, contact techniques are generally limited to simple geometries (e.g., cylindrical tunnels). Finally, contact boring machines generate substantial vibration, which can weaken surrounding structures, destabilize the tunnel, and increase the risk of rock fracturing. Non-contact techniques can reduce or eliminate these vibrations, leading to greater structural integrity and stability, especially in sensitive or urban environments.

What is needed are new non-contact techniques for boring tunnels, trenches, and/or vertical shafts.

### SUMMARY

Described herein are methods and systems for non-contact boring of tunnels, trenches, and/or vertical shafts in rocks (e.g., boulders, solid rocks) and/or transitioning from soil into rocks. A system comprises a chassis, a non-contact boring element, and a boring actuator connecting the non-contact boring element to the chassis and configured to position the non-contact boring element relative to the bore face. These three elements may form an internal subsystem as this subsystem within a tunnel, trench, or shaft. In some examples, a system further comprises an external subsystem, which is positioned away from the tunnel, trench, or shaft. The external subsystem is connected to the internal subsystem using an umbilical cord (e.g., providing power and control signals to the internal subsystem). Furthermore, the system may include an ejecta removal subsystem operationally coupled to the internal and external subsystems. Additional connections may be provided to deliver fuel and air and remove exhaust gases, e.g., when the non-contact boring element is a combustor (e.g., a jet engine, flame jet). In some examples, a non-contact boring element is a plasma torch.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, and methods. These drawings in no way limit any changes in form and detail that may be made by one skilled in the art without departing from the spirit and scope of the disclosed implementations.

FIG. 1 is a schematic cross-sectional top view of a non-contact boring system to form an underground bore, in accordance with some examples.

FIGS. 2-5 illustrate process flowcharts corresponding to a method for automatically adjusting boring parameters based on a bore face, in accordance with some examples.

FIG. 6 is a schematic illustration of a non-contact boring system comprising a chassis, a propulsion subsystem, and a non-contact boring element, such as a plasma torch, a jet engine, or a flame jet, in accordance with some examples.

FIG. 7 illustrates a process flowchart corresponding to a method for non-contact trenching, in accordance with some examples.

FIG. 8 is a schematic illustration of a non-contact boring system for non-contact trenching, in accordance with some examples.

FIGS. 9 and 10 are schematic illustrations of a non-contact boring system for vertical non-contact boring, in accordance with some examples.

FIG. 11 illustrates a process flowchart corresponding to a method for for vertical non-contact boring, in accordance with some examples.

### DETAILED DESCRIPTION

### Examples of Non-Contact Boring Systems

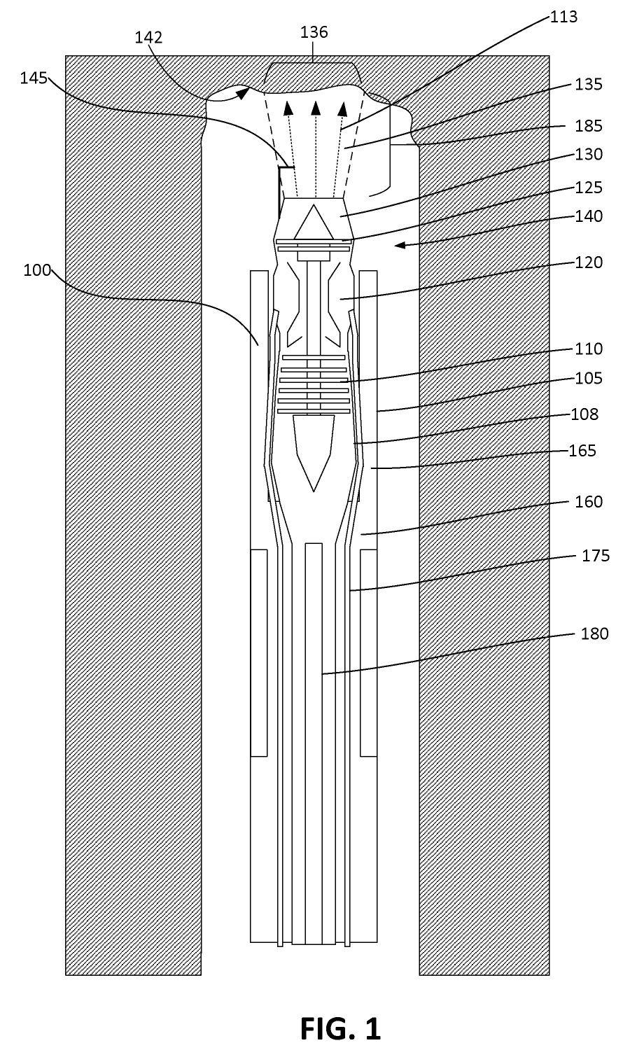

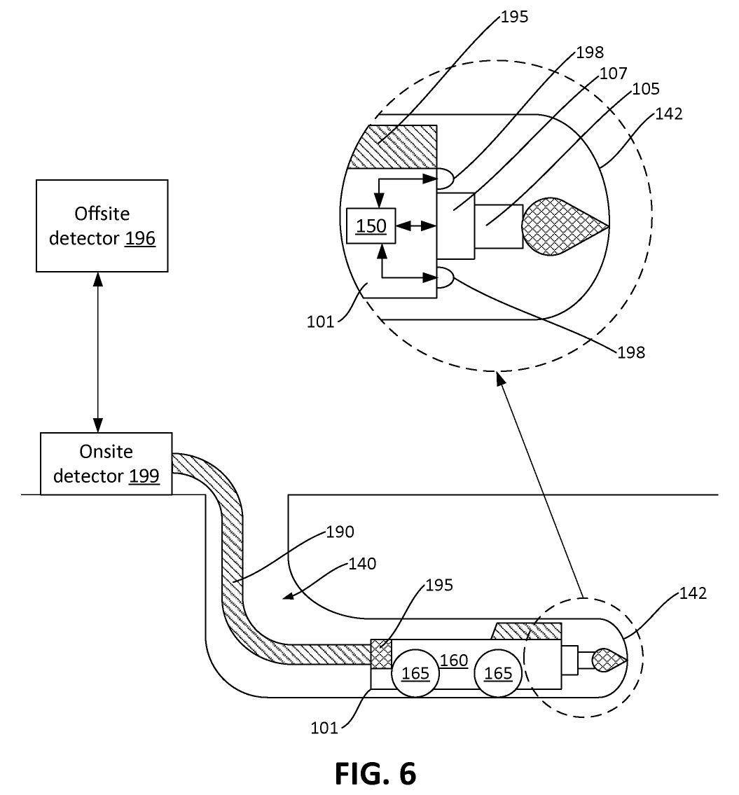

FIG. 1 is a schematic cross-sectional view of a non-contact boring system 100 that can be used to form a bore 140 in an underground tunnel, vertical shaft, and/or trench, in accordance with some examples. Additional features of the non-contact boring system 100 are illustrated in FIG. 6. The non-contact boring system 100 may comprise a non-contact boring element 105, which may be also referred to as a cutterhead. Some examples of a non-contact boring element 105 include a plasma torch, a jet engine, and a flame jet.

In some examples, the non-contact boring element 105 comprises a combustor or, more specifically, an engine 108, such as a jet engine (e.g., a Brayton-cycle turbojet engine and the like). A combustor may include an onboard turbine (e.g., a jet engine) or not include one (e.g., a flame jet). In the later case, compressed air may be delivered remotely. While the following references are made to the engine 108, one having ordinary skill in the art would recognize that various features are also applicable to other types of combustors. The engine 108 comprises a compressor 110 configured to compress air inbound from an above-ground fresh air supply. The engine 108 also comprises a combustor 120 configured to mix compressed air exiting the compressor 110 with fuel inbound from an above-ground fuel supply and to ignite the fuel. The engine 108 may comprise a turbine 125 configured to extract energy from the combusted fuel and compressed air exiting the combustor 120 and to rotate the compressor 110. The engine 108 may comprise a nozzle 130 configured to direct exhaust gases 113 exiting the turbine 125 to induce an area of jet impingement 135 at a bore face 142. The engine 108 may be configured to exhaust high-temperature, high-mass-flowrate exhaust gases toward the bore face 142. These high-temperature, high-mass-flowrate exhaust gases 113 (reaching the bore face 142 within a jet impingement area 136) may thermally shock geologies at the bore face 142, thus leading to spallation of geologies and removal of rock “spall” from the bore face 142.

In some examples, a non-contact boring system 100 further comprises a temperature sensor 145 to measure the temperature of exhaust gases 113 exiting the nozzle 130. The non-contact boring system 100 may also comprise a controller 150 configured to track this temperature based on a signal output by the temperature sensor 145 and to regulate the rate of fuel entering the combustor 120. For example, the temperature of exhaust gases 113 may be maintained below a melting temperature and above a spallation temperature of geology present in the bore 140. Specifically, vitrification at the bore face 142 may lessen or inhibit thermal spallation at the bore face 142 and thus yield a reduction in rock removal per unit time and per unit energy consumed by the non-contact boring system 100 relative to rock removal via spallation. The temperature of the exhaust gases 113 may be maintained below the minimum melting temperature of all geologies present at the face (e.g., less than 900°C) or below the melting temperature of a particular geology detected at the bore face 142 in order to prevent vitrification of the surface of the bore face 142 and maintain spallation across the bore face 142.

In some examples, a non-contact boring system 100 comprises a chassis 160 configured to locate and steer the non-contact boring element 105 within the bore 140. Furthermore, the non-contact boring system 100 may comprise a propulsion subsystem 165 configured to advance the engine and the chassis 160 forward into the bore 140. Various examples of the propulsion subsystem 165 are with the scope, e.g., a set of wheels or tracks driven by an electric, hydraulic, or pneumatic motor.

In some examples, a non-contact boring system 100 can also include a boring-element actuator, which may be referred to as a boring actuator and which may be configured: (a) to locate the non-contact boring element 105 on the chassis 160; (b) to advance and retract the non-contact boring element 105 longitudinally along the chassis 160; (c) to tilt the non-contact boring element 105 in pitch and yaw on the chassis (e.g., by up to +/-5°); and/or (d) to lift the non-contact boring element 105 vertically and shift the non-contact boring element 105 laterally on the chassis 160.

In some examples, a non-contact boring system 100 comprises one or more sensors, such as proximity sensors, e.g., to determine the position of the non-contact boring element 105 relative to the bore face 142. In the same or other examples, a non-contact boring system 100 comprises a spoil evacuator configured to draw or force waste (e.g., gas and spall) from between the non-contact boring system 100 and the bore face 142 to a region behind the non-contact boring system 100 and/or out of the bore, such as via an umbilical cord 190; an on-rig sample collector 195 (which may be also referred to as a filtration or collection apparatus) to collect spoil at the bore face 142, and a power, air, and gas supply configured to supply electrical power, combustion material, and gas to the system.

In some examples, a non-contact boring system further comprises a controller configured to perform one or more of the following functions: (a) generate an optical map of the bore face 142 (e.g., based upon the initial optical composition model), (b) modulate the power, fuel/gas flow rate, and air flow rate (e.g., to control the temperature of the exhaust gases 113), (c) control the drivetrain and stand-off distance, and/or (d) adjust the position of the non-contact boring element 105 on the chassis 160 (e.g., using a boring-element actuator 107).

In some examples, a non-contact boring system 100 comprises an afterburner configured to inject fuel into exhaust gases 113 exiting the turbine in order to rapidly increase the temperature and pressure of exhaust gases 113 reaching the bore face.

### Spallation Process

In some examples, the non-contact boring system 100 is configured to bore through the rock via thermal spallation by directing a high-energy (e.g., high-temperature and/or high-mass flow rate) stream of plasma, exhaust gases 113, and/or other medium toward a bore face 142. These high-energy exhaust gases 113 rapidly transfer thermal energy into the surface of the bore face 142, thus resulting in a rapid thermal expansion of a thin layer of rock at the surface of the bore face 142. Expansion and local stresses occur along natural discontinuities and nonuniformities that exist in the microstructure of the rock matrix. Because geologies are typically brittle, rapid thermal expansion of rock at the surface of the bore face 142 causes this thin, hot surface layer of rock to fracture from the cooler rock behind the bore face 142. This thin, hot surface layer of rock may therefore break into rock fragments (or “spall”) and separate from the surface of the bore face 142 during this “spallation” process. (The mechanism of fracturing or induction of micro-stresses at the surface of the bore face 142 may vary across lithologies based on mineralogy, material properties, chemical properties, and physical properties of the surface subjected to these exhaust gases 113.)

However, if the temperature of the exhaust gases 113 reaching the bore face 142 exceeds the melting temperature of the geology at the surface of bore face 142, the surface of the bore face 142 may melt and flow down the bore face 142 rather than fracture and release from the bore face 142. Molten rock may absorb more energy per unit mass than spall. Molten rock may also flow slowly down the bore face 142 rather than breaking and releasing from the surface of the bore face 142 like a spall. Finally, molten rock may thermally shield non-molten material on the bore face 142 (e.g., material directly behind or around the area of molten material) from the energy carried by the exhaust gases output by the engine. Therefore, relative to spallation, molten rock at the bore face 142 may result in an immediate reduction in the volume or mass of rock removed from the bore face 142 per unit of time and per unit of energy consumed by the engine (e.g., because the energy consumed by the engine is thus directed to changing the phase of rock at the bore face 142 rather than sequentially fracturing thin layers of rock from the bore face 142).

Exhaust gases 113, generated by the engine 108, are directed at a high-volume flow rate in order to maintain a high pressure and a high total heat flux at the bore face 142 and to achieve rapid spallation and material removal from the bore face 142. The non-contact boring system 100 can also implement closed-loop controls to maintain the temperature of these exhaust gases below the melting temperature of all geologies (e.g., 825°C to compensate for melting temperatures between 900°C and 1400°C for most geologies) or below a particular geology detected at the bore face 142. A geology at the bore face 142 may therefore be (very) unlikely to melt in the presence of these exhaust gases from the engine. The non-contact boring system 100 can also maintain a high mass flow rate in order to compensate for sub-melting-temperature exhaust temperatures in order to generate high heat flux at the bore face 142 – and therefore a high rate of spallation of rock at the bore face 142 – with a low risk of melting the bore face 142 over a wide range of geologies.

As noted above, the engine 108 may comprise (a) a combustor 120 that burns fuels, (b) a turbine 125 that transforms pressure and thermal energy of gases exiting the combustor 120 into mechanical rotation of a driveshaft, and (c) an integrated axial compressor 110 that is powered by the turbine 125 via the driveshaft to draw air into the engine 108, to compress this air, and to feed this air into the combustor 120. As such, the engine 108 may be fully contained and may require no or minimal external (i.e., above-ground) support systems in order to bore through various geologies. In particular, the non-contact boring system 100 can be connected solely to: an air supply that feeds fresh, unconditioned, above-ground air at any temperature and humidity into the compressor; a fuel supply that feeds fuel from an above-ground supply (e.g., a fuel tank) into a fuel metering unit within the engine; and/or an above-ground monitoring system or remote control via low-power sensor and data lines.

Therefore, substantially all energy consumed during a boring operation may be consumed at the bore face 142 by the engine 108 to convert chemical energy in the fuel into (a) the heat at the bore face 142, (b) the kinetic energy of exhaust gases 113 producing pressure at the bore face 142, (c) the kinetic energy of exhaust gases 113 moving off of the bore face 142 and drawing spall rearward behind the engine, and (d) the kinetic energy to rotate the turbine 125 and compressor 110. In particular, because the compressor 110 and combustor 120 are fully integrated into the engine 108 and because the engine 108 is configured to function solely on (unconditioned) air and fuel supplies, the non-contact boring system 100 may require that no or minimal energy be consumed by fans, pumps, cooling systems, etc. to power and cool above-ground subsystems or to pump air to the engine 108.

### Setting Up Systems for Operation

A non-contact boring system 100 requires minimal set-up activities and time to start the boring operation. The following example is directed to boring an underground tunnel. However, one having ordinary skill in the art would appreciate how this example is applicable to trenching and vertical shaft boring. For example, an operator may: (a) dig a shallow trench at the start of the tunnel; (b) place the non-contact boring system 100 in the trench; (c) connect a fuel supply line extending rearward from the non-contact boring system 100 to an above-ground fuel reservoir (e.g., a mobile fueling rig); (d) locate an end of an air supply line 180 – extending rearward from the non-contact boring system 100 – in an unobstructed above-ground location; and (e) start the engine 108 (e.g., with a small electric starter motor integrated into the non-contact boring system 100). The first two steps may not be needed for trenching and vertical shaft boring.

The engine 108 may then: (a) draw the air into the compressor 110 via the air supply line 180; (b) combust pressurized air and fuel in the combustor 120; (c) extract some energy from the resulting exhaust gases 113 at the turbine 125 to power the compressor 110; and (d) eject hot exhaust gases 113 at high mass flow rate toward the bore face 142 to spallate and remove material from the bore face 142. Concurrently, the propulsion subsystem 165 can move the engine 108 forward at a rate proportional to material removal from the bore face 142 to maintain a standoff distance 185 between the nozzle 130 and the bore face 142. Additionally, or alternatively, the propulsion subsystem 165 can move the engine 108 forward based on material removal from the bore face 142, the temperature and velocity of the exhaust gases 113 exiting the nozzle 130, raster rate of the nozzle 130 across the bore face 142, and/or the standoff distance 185 to maintain consistent heat flux across the bore face 142.

The non-contact boring system 100 can also collect spoil samples at the bore face 142 and at an above-grade location for further analysis and updating of the initial bore composition model. As the non-contact boring system 100 advances through the tunnel, improved bore composition models can be received at the non-contact boring system 100 to improve the accuracy of its geologic images and in turn the efficiency of its boring performance. The non-contact boring system 100 can fuse the collected images to generate a full geological or mineralogical map of the tunnel through repeated detection, imaging, collection, analysis, and refinement of the iterative bore composition models.

Thus, the non-contact boring system 100 can function to remove material from the bore face 142 without substantive above-ground air and power support systems, thereby simplifying the setup and deployment of the non-contact boring system 100.

### Examples of Fuel Supplies and Fuel Pumps

In some examples, a non-contact boring system 100 includes or couples to a fuel supply line 175. The fuel supply line 175 may be a thermally-shielded flexible fuel line that connects to an above-ground fuel supply (e.g., a mobile diesel fuel tank), runs through the tunnel, and connects to the engine 108 to supply fuel to the engine 108 during operation.

The non-contact boring system 100 can also include a fuel pump integrated into the engine 108 and configured to draw the fuel from the above-ground fuel supply through the fuel supply line 175 and to maintain a minimal fuel pressure within the engine 108. For example, the non-contact boring system 100 can include a mechanical fuel pump driven by power from the turbine 125. Alternatively, the non-contact boring system 100 can include: an electric fuel pump; and an electric generator (or an electric starter motor operated in a generator mode) driven by a power takeoff from the turbine 125 and supplying power to the electric fuel pump to draw fuel from the above-ground fuel supply.

Additionally, or alternatively, the above-ground fuel supply can include a fuel pump configured to push fuel toward the engine 108 via the fuel supply line 175. Furthermore, the non-contact boring system 100 can include a series of inline fuel pumps arranged along the fuel supply line 175 and configured to boost fuel pressure and maintain fuel flow along the fuel supply line 175, such as over extended tunnel bore lengths (e.g., dozen, hundreds of feet).

Furthermore, the fuel supply line 175 runs from the fuel supply line 175, along the tunnel, to the engine 108. Accordingly, the fuel supply line 175 may be heated by exhaust gases moving off the bore face 142, around the engine 108, and rearward though the tunnel toward a tunnel opening behind the engine 108. The fuel running through the fuel supply line 175 may therefore be heated by these exhaust gases 113 on its way to the engine 108 and may thus recapture some thermal energy from these exhaust gases 113 and return this thermal energy to the engine 108, which then redirects this recycled heat – with additional heat from burning this fuel – back to the bore face 142.

### Examples of Air Supplies

The non-contact boring system 100 also includes or couples to an air supply line 180 (or “hose”) that includes an inlet above ground, runs through the tunnel behind the engine 108, connects to the inlet of the engine 108, and supplies air (or “working fluid”) to the compressor 110 during operation. In particular, the air supply line 180 feeds fresh air from above grade to the engine 108, which then compresses this fresh air in the compressor 110, mixes this compressed fresh air with fuel received via the fuel supply line 175, ignites this air-fuel mixture in the combustor 120, extracts some energy from combusted and expanding exhaust gases 113 via the turbine 125 to rotate the compressor 110, and then releases these high-temperature high-mass-flowrate exhaust gases 113 toward the bore to spallate and remove material from the bore face 142.

For example, the air supply line 180 can include: a flexible duct hose; and heat shielding over a first section of the flexible duct hose immediately trailing the engine 108 (e.g., a ten-foot section of the air line immediately behind the engine 108) and configured to shield the flexible duct hose from high-temperature exhaust gases 113 and spall moving off of the bore face 142 and around the engine 108. In this example, the air supply line 180 can also exclude heat shielding over the remainder of the flexible duct hose. Accordingly, this second section of the flexible duct hose may be heated by exhaust gases 113 moving behind the engine 108 and around the flexible duct hose. Fresh air moving through the duct hose may therefore be heated by these exhaust gases 113 on its way to the engine 108 and may thus recapture some thermal energy from these exhaust gases 113 and return this thermal energy to the engine 108, which then redirects this recycled heat – with additional heat from burning the fuel – back to the bore face 142. Thus, in these examples, the air supply line 180 can function as a heat exchanger to recycle heat moving off of the bore face 142 and to return this heat to the engine 108.

### Examples of Compressors

The compressor 110 is configured to compress air inbound from an above-ground fresh air supply. Generally, the compressor 110 is described herein as defining an axial compressor coupled to, driven by, and arranged coaxially with the turbine 125. For example, the compressor 110 can include a single- or multi-stage axial compressor including: a set of compressor stator vanes fixedly mounted to the engine; a compressor rotor rotating within the engine; and a set of compressor rotor vanes mounted to the compressor rotor. However, the compressor 110 can alternatively include a centrifugal compressor. The compressor 110 can also be non-axial with the turbine 125 and can be driven by the turbine 125 via a gearbox, belt drive, or other power transmission subsystem.

### Examples of Combustors

The combustor 120 is configured to mix compressed air exiting the compressor 110 with fuel inbound from the fuel supply and to ignite this fuel mixture. In some examples, the combustor 120 includes a flame tube defining: a primary zone including a first set of perforations; and a dilution zone including a second set of perforations. More specifically, the combustor 120 may also include a fuel injector that sprays the fuel into the flame tube ahead of the primary zone. During operation, the first portion of compressed air – exiting the compressor 110 – moves into the primary zone of the flame tube via the first set of perforations and mixes with the fuel to form an air-fuel mixture at or near a target ratio (e.g., leaner than a stoichiometric ratio). This air-fuel mixture then combusts (nearly completely) within the primary zone of the flame tube at (near) constant pressure and flows into the dilution zone on its way to the turbine. Concurrently, a second portion of air – exiting the compressor 110 – moves around and outside of the primary zone of the flame tube, passes through the second set of perforations in the flame tube, and mixes with high-temperature combustion products moving from the primary zone to the dilution zone of the flame tube. This second portion of compressed air may be much cooler than these high-temperature combustion products and may thus reduce the average temperature of combustion products exiting the combustor 120 and thus reduce the average temperature of exhaust gases subsequently exiting the nozzle and directed toward the bore face 142.

As described below, the non-contact boring system 100 can also control a “dilution ratio” of the first portion of compressed air to the second portion of compressed air entering and diverted around the flame tube, respectively, in order to maintain a target air-fuel mixture within the primary zone of the flame tube and to control exhaust gas temperature when adjusting the fuel flow rate into the combustor 120. Furthermore, the combustor 120 can include multiple flame tubes arranged in parallel between the compressor 110 and the turbine.

### Examples of Turbines

The turbine 125 is configured to extract energy from combusted products exiting the combustor and to rotate the compressor 110. In particular, the turbine 125 can include: a set of turbine stator vanes mounted to the engine; a turbine rotor rotating within the engine and coupled to the compressor rotor (e.g., via a driveshaft and/or gearbox); and a set of turbine rotor vanes mounted to the turbine rotor. Combustion products exiting the combustor 120 may expand isentropically while moving through the turbine stator and rotor vanes of the turbine 125, thus reducing the temperature and pressure of these combustion products and transforming this energy into rotation of the compressor 110.

### Examples of Nozzles

The nozzle 130 is coupled to the output of the turbine 125 and is configured to direct exhaust gases 113 exiting the turbine 125 onto a jet impingement area 136 at the bore face 142. In some examples, the non-contact boring system 100 includes a fixed-area nozzle 130 that directs exhaust gases 113 toward the bore face 142 to form a jet impingement area 136 of a target size (e.g., a target diameter) on the bore face 142 at a target standoff distance 185 (or within a narrow range of target standoff distances 185) between the nozzle 130 and the bore face 142. For example, the fixed-area nozzle 130 can define a nozzle geometry that yields an impingement area 136 of width approximately ten times the width of the nozzle 130 in order to achieve: a stream of exhaust gases 113 that includes a hot center region shielded by a thick boundary layer; an efficient convection within the center region; a high rate of heat transfer from the center stream into the bore face 142; and thus a high rate of spallation within the jet impingement area 136.

Thus, in some examples, the non-contact boring system 100 can control standoff distance 185 and angular position of the nozzle 130 on the chassis 160 – and therefore relative to the bore face 142 – to induce a jet impingement of controlled area on the surface of the bore face 142 and thus evenly excavate one discrete cross-section of the face of the bore before advancing the chassis 160 forward.

In one variation, the non-contact boring system 100 includes a variable-area nozzle 130. In this variation, by adjusting the area of the nozzle 130, the controller 150 can adjust the jet impingement area 136 at the bore face 142 and thus control power density (i.e., heat flux per unit area) within the jet impingement area 136 at the bore face 142.

Generally, the speed of the compressor 110 may be correlated with the mass flow rate of air through the engine and thus a pressure within the jet impingement area 136 at the bore face 142. Similarly, the fuel flow rate may be correlated with exhaust gas temperature and turbine 125 and compressor 110 speeds. Thus, during operation, the controller 150 can implement closed-loop controls to: increase fuel flow rate in order to raise the exhaust gas temperature to a (fixed or variable) target temperature; and increase the nozzle 130 area in order to compensate for higher compressor 110 speeds resulting from increased fuel flow rate and thus maintain a controlled (e.g., constant) pressure across the jet impingement area 136; and vice versa

In a similar example, the controller 150 can implement closed-loop controls to increase the nozzle 130 area at higher compressor 110 speeds in order to reduce the speed of exhaust gases exiting the nozzle 130 and thus maintain the exhaust gas stream at subsonic speeds.

Conversely, the controller 150 can adjust the nozzle 130 area to: maintain a supersonic exhaust gas stream; and locate a first shock diamond (i.e., an abrupt change in local density and pressure) in the exhaust gas stream at the bore face 142. The complex flow of exhaust gases 113 within and around this shock diamond – positioned at the bore face 142 by the non-contact boring system 100 – may result in a high rate of heat transfer, thermal shock, and pressure shock across the jet impingement area 136, which may yield a high rate of spallation and material removal from the jet impingement area 136. Thus, in some examples, the controller 150 can: monitor a standoff distance 185 from the engine to the bore face 142 (e.g., with a mechanical contact probe or a contactless distance sensor, such as described above); and adjust the nozzle 130 area based on the current exhaust gas temperature, the current air flow rate (or compressor 110 speed, turbine 125 speed) through the engine, 108 and the current standoff distance in order to locate a shock diamond (e.g., the first shock diamond) in the exhaust gas flow at the current standoff distance and thus produce thermal and pressure shocks at the bore face 142 that yield an increased rate of material removal.

In another example, the controller 150 can reduce the nozzle 130 area when hard geologies (e.g., igneous and metamorphic rocks) are present at the bore face 142 in order to: achieve greater energy density within the jet impingement area 136 and maintain a high rate of spallation within the jet impingement area 136 despite these harder geologies; while also maintaining exhaust gas temperatures below the low melting temperatures of softer geologies in order to prevent melting at the bore face 142 under mixed-geology bore face 142 conditions or during transitions from harder geologies to softer geologies along the tunnel. Similarly, in this example, the controller 150 can increase the nozzle 130 area when soft geologies (e.g., sedimentary rocks) are present at the bore face 142 in order to increase the size of the jet impingement area 136 and thus maintain a high rate of spallation over a wider bore area with more uniform rock removal across the width and height of the bore 140.

### Examples of Controllers

As noted above, a non-contact boring system 100 may comprise a controller 150 and a temperature sensor 145 (e.g., a thermocouple) arranged near an exit of the nozzle 130 (e.g., between the nozzle and the bore face). The non-contact boring system 100 may further comprise a fuel metering unit configured to adjust the rate of fuel injected into a flame tube. The controller 150 can: (a) set a target exhaust gas temperature, such as described below; (b) sample the temperature sensor 145 to track the temperature of exhaust gases 113 exiting the nozzle; and (c) implement closed-loop controls. For example, the controller 150 may adjust the fuel metering unit to increase the rate of fuel injected into the flame tube if the temperature of these exhaust gases 113 is less than the target temperature. Alternatively, the controller 150 may adjust the air metering unit to decrease the rate of fuel injected into the flame tube if the temperature of the exhaust gases 113 is more than the target temperature. For example, the controller 150 may be configured to (a) read the temperature of exhaust gases 113 at a frequency of at least 10 Hertz, and (b) then calculate an average of these temperatures and update the fuel flow rate based on this average temperature at a frequency of at least 1 Hertz.

In another example, the non-contact boring system 100 includes a contact-based or contactless distance sensor configured to detect a standoff distance 185 between the engine 108 and the bore face 142. In this example, the controller 150 regularly samples the distance sensor and calculates a current boring rate at the bore face 142 based on changes in this standoff distance 185 over a period of time (and a distance that the propulsion subsystem and/or chassis 160 advanced the engine 108 forward within the period of time).

The controller 150 can also regularly implement temperature test loops, including: increasing the target exhaust gas temperature; adjusting fuel flow rate and/or dilution ratio to achieve this exhaust gas temperature; measuring standoff distance 185; and calculating a current boring rate, and repeating this temperature test loop. If the current boring rate is greater than the previous boring rate at a lower target temperature (e.g., if the material at the bore face 142 is now spallating and releasing from the bore face 142 at a greater rate), the controller 150 can further increase the target exhaust gas temperature and repeat the process. However, if the current boring rate is less than the previous boring rate at the lower target temperature (e.g., if the material at the bore face 142 is now melting rather than spallating), the controller 150 can decrease the target exhaust gas temperature and repeat this temperature test loop. Thus, in this example, the controller 150 can adjust the target exhaust gas temperature based on real-time boring rates, such as including: increasing the target exhaust gas temperature to maintain high thermal shock and spallation of harder geologies; and decreasing the target exhaust gas temperature to prevent melting of softer geologies, thereby maintaining the exhaust temperature above the average spallation temperature of the surface and below the minimum melting temperature of any point on the surface and thus maximizing material removed from the bore face 142.

In another example, the non-contact boring system 100 includes an optical sensor directed toward the bore face 142 and configured to output images (e.g., color images, infrared images) of jet impingement area at the bore face 142. In this example, the controller 150: accesses an image of the bore face 142 captured by the thermal imaging sensor; and scans the image for “bright” (i.e., high intensity, high color value) pixels that indicate molten material at the bore face 142. If the controller 150 thus detects a “bright” region in the image thus indicating molten material at the bore face 142, the controller 150 can reduce the target exhaust gas temperature. Conversely, if the controller 150 detects no “bright” region in the image thus indicating no molten material at the bore face 142, then the controller 150 can increase the target exhaust gas temperature. The controller 150 can then adjust the fuel flow rate and/or the dilution ratio at the combustor 120 to achieve this updated target exhaust gas temperature. The controller 150 can regularly repeat this process, such as at a frequency of 1 Hertz.

In the foregoing example, the controller 150 can implement similar methods and techniques to detect higher temperature – but not yet molten – regions on the bore face 142 (e.g., “hot spots”) based on images captured by the optical sensor and to update the target exhaust gas temperature accordingly.

Additionally or alternatively, the non-contact boring system 100 can: implement object-tracking techniques to detect and track material moving off of the bore face 142 based on features detected in a sequence of images captured by the optical sensor; and estimate temperatures or phases of this material based on color, brightness, and/or intensity of pixels identified as spall in these images. The controller 150 can then increase the target exhaust gas temperature if no molten material moving off of the bore face 142 is detected; and vice versa.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

### Examples of Air Metering Units

In one variation, the non-contact boring system 100 further includes an air metering unit configured to vary a “dilution ratio” of the first portion of compressed air entering the primary zone of the flame tube; to the second portion of compressed air entering the dilution zone of the flame tube.

In some examples, the air metering unit includes a sleeve configured to slide over a range of positions along the flame tube, such as including: a 1:0 dilution ratio position in which the sleeve fully exposes the first set of perforations and fully encloses the second set of perforations in the flame tube; a 2:1 dilution ratio position in which the sleeve predominantly exposes the first set of perforations and predominantly encloses the second set of perforations in the flame tube; a 1:1 dilution ratio position in which the sleeve similarly exposes the first and second sets of perforations in the flame tube; and a 1:2 dilution ratio position in which the sleeve predominantly encloses the first set of perforations and predominantly exposes the second set of perforations in the flame tube; etc. In this implementation, the air metering unit can also include an actuator configured to transition the sleeve along this range of positions. Thus, during operation, the controller can set a target exhaust gas temperature, such as described below, detect the temperature of the exhaust gases 113 exiting the nozzle 130, and implement closed-loop controls to: adjust the air metering unit to increase the dilution ratio – and increase the fuel flow rate accordingly to maintain a target air-fuel ratio – if the temperature of the exhaust gases 113 is less than the target temperature; and adjust the air metering unit to decrease the dilution ratio – and decrease the fuel flow rate accordingly to maintain the target air-fuel ratio – if the temperature of the exhaust gases is more than the target temperature.

### Example of Spall Removal from Bore Face

In one variation, the non-contact boring system 100 further includes: a compressor tap arranged between the compressor and the combustor; and a low-temperature jet coupled to the compressor tap, arranged near the bore face 142, and configured to blow spall – removed from the bore face 142 by high-temperature exhaust gases 113 output from the nozzle 130 – away from the bore face 142 and rearward behind the engine 108.

For example, the low-temperature jet can be arranged below the nozzle 130 and can face downwardly and/or toward a bottom corner of the bore face 142 such that compressed air discharged by the low-temperature jet displaces spall – falling from the bore face 142 and collecting in this bottom corner of the bore face 142 – rearward, thereby exposing the bottom of the bore face 142 to spallation by exhaust gases 113 discharged from the nozzle 130. The non-contact boring system 100 can thus: bleed a third portion of compressed air from the output of the compressor via the compressor tap and feed this compressed air to the low-temperature jet; blast this third portion of compressed air toward the bottom corner of the bore; draw spall and larger rock fragments – that may otherwise collect along the bottom of the bore face 142 – rearward; and thus expose the bottom corner of the bore face 142 to the nozzle 130 for further spallation.

Additionally, or alternatively, in this variation, the non-contact boring system 100 can include a set of low-temperature jets arranged about the outer casing of the engine 108 near the nozzle 130, facing reward on the engine 108 (i.e., opposite the bore face 142), and connected to the compressor tap. In some examples, the set of low-temperature jets can direct low-temperature air along the outer casing of the engine 108 in order to form a cool boundary layer along the casing, which may thermally shield the casing from hot exhaust gases 113 and spall moving off of the bore face 142 and flowing around the engine 108 during operation.

In another variation, the non-contact boring system 100 further includes a fan: arranged ahead of the compressor; coupled to the air supply line; driven by the turbine 125 (e.g., in a high-bypass fan configuration); and configured to output a second stream of low-temperature compressed air separate from the compressor, the combustor, and the nozzle 130. In this variation, the non-contact boring system 100 can also include a flow reversal subsystem (e.g., in a clamshell configuration) configured to direct this second stream of low-temperature compressed air rearward and away from the bore face 142 in order to draw spall – moving off of the bore face 142 – away from the bore face 142, past the engine 108, and out of the tunnel. For example, the flow reversal subsystem can: direct the second stream of low-temperature compressed air rearward (i.e., away from the bore face 142; opposite the direction of air flowing from the air supply into the engine 108); thus creating a lower-pressure region between the rear of the engine 108 and the bore face 142 in order to increase flow rate of exhaust gases 113 and spall around and past the engine 108; and cool the outer casing of the engine 108.

### Examples of Chassis and Propulsion Subsystems

The engine 108 can be mounted on the chassis 160, and the propulsion subsystem 165 can advance the chassis 160 and the engine 108 forward toward the newly-exposed surface of the bore face 142 as the non-contact boring system 100 bores the tunnel.

For example, the chassis 160 and the propulsion subsystem 165 can form a wheeled or tracked cart driven by electric, hydraulic, or pneumatic motors powered via a generator, pump, or compressed air tap, etc. connected to the engine 108. The chassis 160 can also include a boring-element actuator 107 configured: to locate the engine 108 on the chassis 160; to advance and retract the engine 108 longitudinally along the chassis 160 in order to maintain a standoff distance 185 between the nozzle 130 and the bore face 142; to pitch and yaw the engine 108 on the chassis 160 (e.g., by up to +/-10° in pitch and yaw) in order to scan (or “raster”) the jet impingement area 136 across the bore face 142; and/or to lift the engine 108 vertically and shift the engine 108 laterally on the chassis 160 in order to scan the jet impingement area 136 across the bore face 142.

For example, during operation, the controller 150 can: fully retract the boring-element actuator 107; advance the propulsion subsystem 165 forward to locate the nozzle 130 at (approximately) a target standoff distance 185 from the bore face 142; raster the nozzle 130 across the bore face 142 in order to spallate and remove rock over a bore face 142 area larger than the jet impingement area 136 and the cross-section of the non-contact boring system 100; selectively pause (or “dwell”) the nozzle 130 to locate the jet impingement area 136 at a low boring rate region of the bore face 142; and advance the boring-element actuator 107 forward by an (average) removal depth during this raster cycle. The controller 150 can repeat this process over multiple raster cycles until the boring-element actuator 107 reaches the extent of its forward travel, at which time the controller 150 can fully retract the boring-element actuator 107 and advance the propulsion subsystem 165 forward to locate the nozzle 130 at (approximately) the target standoff distance 185 from the bore face 142 before repeating this process. Furthermore, in this example, the controller 150 can: maintain a consistent fuel flow rate through the engine 108 and thus maintain a consistent temperature and pressure of exhaust gases 113 exiting the nozzle 130; and modulate a scan rate that the propulsion system rasters the nozzle 130 across the bore face 142 in order to achieve a target bore size (e.g., width and height) and a target bore profile (e.g., a D-shape) over the length of the bore.

### Application Examples

Overall, the non-contact boring system 100 can be configured to modulate temperature, power, gas flow rate, orientation, advance rate, and standoff distance as a function of bore geology in order to maintain efficient boring. More specifically, the non-contact boring system 100 may execute non-contact boring at a bore face with a predetermined set of boring parameters (e.g., impingement temperature, dwell time, stand-off distance, raster rate, raster pattern, or pressure) based upon an initial or nominal understanding of the bore face geology; detect electromagnetic (e.g., light) signals emitted from the bore face during non-contact boring; generate a representative image that correlates with geological profile of the bore face using the detected signals and an initial optical composition model that correlates frequencies of emissions with geological characteristics; and adjust a set of the boring parameters in response to the representative image indicating a geological profile different from the nominal understanding of the bore face geology.

Generally, the non-contact boring system 100 may bore through geologies in a non-contact manner (e.g., plasma torch, jet engine, flame jet torch) in order to avoid melting rock (e.g., creating lava) and instead maintain spoil in the form of a gas (e.g., gaseous carbonate) with spall (e.g., rock flakes), thereby enabling a spoil evacuator within the system to draw spoil – removed from the bore face – rearward and out of the bore with limited spoil entrapment between the system and the bore face and with limited collection of spoil along the spoil evacuator (e.g., due to condensation of molten rock or “slag” on cooler surfaces within the spoil evacuator). The non-contact boring system 100 may sweep a non-contact boring apparatus across the bore face in a predetermined raster pattern or raster rate with predetermined temperature and pressure parameters and at a predetermined stand-off distance.

Generally, in non-contact boring, a thermal load is directed toward the bore face to generate spallation. When a thermal load of sufficient magnitude is applied to a chemical composition excitation in the molecules and atoms occurs. When the thermal load is released, these excitations are relaxed through the release of electromagnetic radiation (photons) along known spectra for each excitation. In this way, the system can detect the relaxation phenomena using a detector, such as a camera, and then analyze the frequency and amplitude of the various relaxations to determine the chemical makeup of the bore face geology.

The non-contact boring system 100 may adapt non-contact boring parameters during the boring process. For example, various geologies may contain crystalline silicon dioxide (SiO₂) in large proportions, such as sandstone, granite, and basalt. Basalt commonly contains 30-40% silicon dioxide (SiO₂) by volume and may contain as much as 80% silicon dioxide (SiO₂) by volume. Silicon dioxide (SiO₂) exhibits a relatively low melting temperature. However, the crystalline structure of silicon dioxide (SiO₂) may decompose below the melting temperature of silicon dioxide (SiO₂). Therefore, the system can implement Blocks of the method to detect the presence of silicon dioxide (SiO₂) in the bore face through detection, and then control the non-contact boring parameters to maintain an optimal temperature at the bore face near the crystalline decomposition temperature of silicon dioxide (SiO₂) – and below the melting temperature of silicon dioxide (SiO₂) –to decompose the crystalline structure of material across the bore face and to thus fracture (or disintegrate) this material while not melting this material.

Therefore, by detecting emissions from the bore face while the bore face is being heated through non-contact boring, the non-contact boring system 100 can: generate a geologic image of the bore face that contains information regarding the mineral composition and mineral location along the bore face; use an initial optical composition model, determine a type, concentration, and location of certain types of minerals; and adjust a non-contact boring parameter such as temperature, pressure, stand-off distance, dwell time, raster pattern, or raster rate of the non-contact boring element. Furthermore, by characterizing the geologic characteristics of the bore face, the non-contact boring system 100 can detect particularly resilient or vulnerable materials at the bore face and adjust a non-contact boring parameter to maintain the efficiency of the boring process, for example by increasing temperature, pressure, and dwell time in areas of high resilience and decreasing the same in areas of high vulnerability.

In some examples, the non-contact boring system 100 may collect additional samples at the bore face using a set of filters that capture or trap spoil in particulate or gaseous form. The set of filters can be sequenced or tagged by or at a location along the tunnel and corresponding to a particular image detected at the bore face. The non-contact boring system 100 can then further analyze the collected samples to determine any discrepancies between the imaged bore face and the initial optical composition model, which can be used to update and refine the optical composition model.

The non-contact boring system 100 may collect exhaust or emissions from the tunnel at an above-grade detector, tag or correlate those samples with a particular time or location of non-contact boring activity and store the samples for further analysis. The collected samples can, in turn, be used to update the initial optical composition model to increase boring efficiency and generate a comprehensive geological map of the tunnel through repeated sampling.

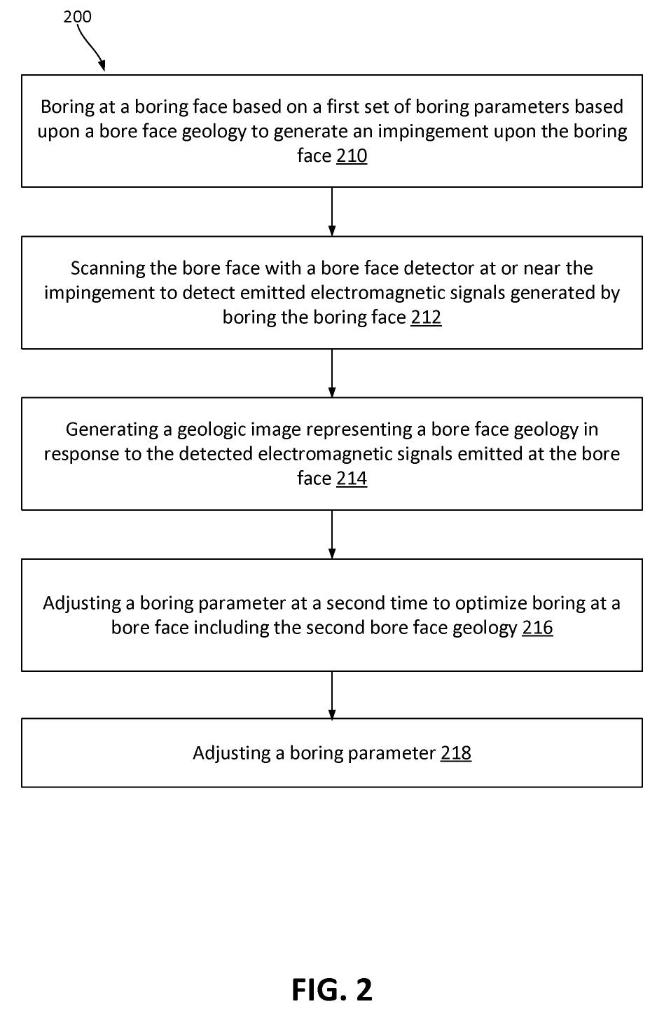

FIGS. 2-5: Examples of methods for adjusting boring parameters

Referring to FIG. 2, in some examples, method 200 for automatically adjusting boring parameters based on a bore face 142 comprises (block 210) at a first time, with a boring rig including a non-contact boring apparatus, boring at a boring face 142 based on a first set of boring parameters based upon a first bore face geology to generate an impingement upon the boring face 142; (block 212) scanning the bore face 142 with a bore face detector at or near the impingement to detect emitted electromagnetic signals generated by boring the boring face 142; (block 214) based on an initial optical composition model, generating a geologic image representing a second bore face geology in response to the detected electromagnetic signals emitted at the bore face 142; (block 216) in response to differences between the first bore face geology and the second bore face geology, adjusting a boring parameter at a second time to optimize boring at a bore face 142 including the second bore face geology. In some examples, method 200 comprises (block 218) adjusting a boring parameter, wherein a boring parameter includes impingement temperature, dwell time, stand-off distance, raster rate, raster pattern, or pressure.

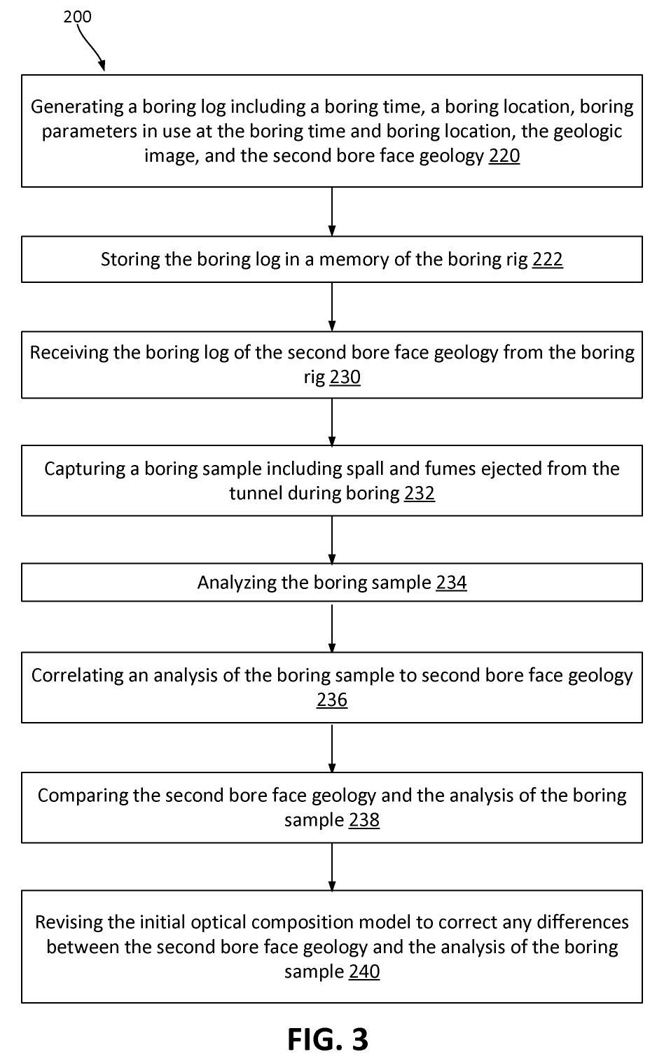

Referring to FIG. 3, in some examples, method 200 comprises (block 220) generating a boring log including a boring time, a boring location, boring parameters in use at the boring time and boring location, the geologic image, and the second bore face geology (block 222) storing the boring log in memory of the boring. The method 200 may proceed with (block 230) at an onsite detector, receiving the boring log of the second bore face geology from the boring rig; (block 232) at the onsite detector, capturing a boring sample including spall and fumes ejected from the tunnel during boring; (block 234) at the onsite detector, analyzing the boring sample; (block 236) at the onsite detector, correlating an analysis of the boring sample to second bore face geology; (block 238) at the onsite detector, comparing the second bore face geology and the analysis of the boring sample; and (block 240) at the onsite detector, revising the initial optical composition model to correct any differences between the second bore face geology and the analysis of the boring sample.

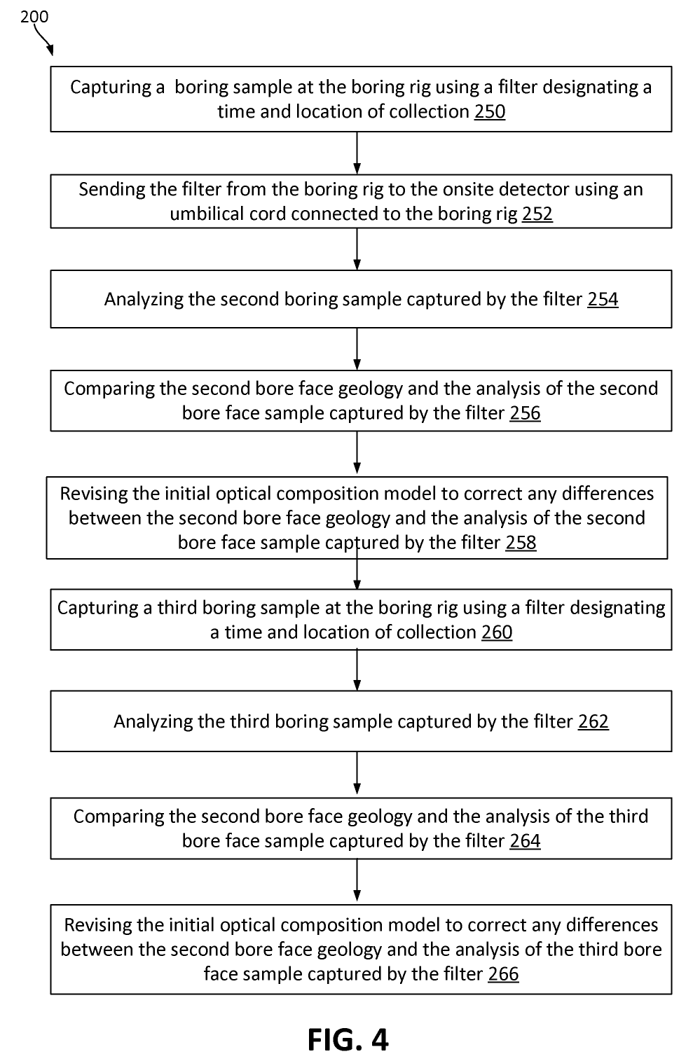

Referring to FIG. 4, in some examples, method 200 comprises (block 250) capturing a second boring sample at the boring rig using a filter designating a time and location of collection; (block 252) sending the filter from the boring rig to the onsite detector using an umbilical cord connected to the boring rig; (block 254) at the onsite detector, analyzing the second boring sample captured by the filter; (block 256) at the onsite detector, comparing the second bore face geology and the analysis of the second bore face sample captured by the filter; and (block 258) at the onsite detector, revising the initial optical composition model to correct any differences between the second bore face geology and the analysis of the second bore face sample captured by the filter in Block 258.

Continuing with FIG. 4, in some examples, method 200 comprises (block 260) capturing a third boring sample at the boring rig using a filter designating a time and location of the collection; (block 262) at an offsite detector, analyzing the third boring sample captured by the filter; (block 264) at the offsite detector, comparing the second bore face geology and the analysis of the third bore face sample captured by the filter; and (block 266) at the offsite detector, revising the initial optical composition model to correct any differences between the second bore face geology and the analysis of the third bore face sample captured by the filter.

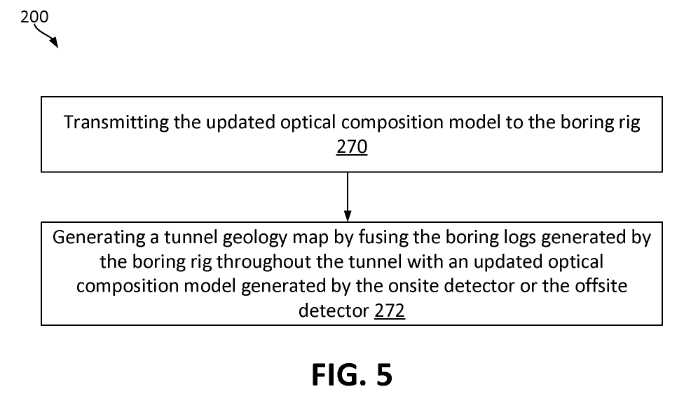

Referring to FIG. 5, in some examples, method 200 comprises (block 270) transmitting the updated optical composition model to the boring rig; and (block 272) at the onsite detector, generating a tunnel geology map by fusing the boring logs generated by the boring rig throughout the tunnel with an updated optical composition model generated by the onsite detector or the offsite detector.

In some examples, method 200 comprises determining a chemical composition of the bore face 142 based upon detected spectral detections and correlations between the detected spectra and known or modeled geologies.

### Detection and Image Processing Examples

In some examples, the non-contact boring system 100 is configured to (a) detect frequencies and amplitudes of photons emitted at the bore face 142 during non-contact boring and (b) convert the detected frequencies and amplitudes into an image of the bore face 142. For example, the non-contact boring system 100 can scan the bore face 142 at or near the point of non-contact thermal impingement from a nominal standoff distance. Alternatively, the non-contact boring system 100 can implement a full-face static scan of the bore face 142 to detect photons emitted after impingement by the non-contact boring element 105. In some examples, the non-contact boring system 100 can follow a raster pattern of the non-contact boring element sub-assembly, for example by being attached to or moving in concert with the boring-element actuator 107.

In more specific examples, the non-contact boring system 100 is configured to detect and interpret photons emitted at the bore face using a red-green-blue (RGB) camera detector, a cyan-magenta-yellow-black (CMYK) camera detector, and/or an infrared detector. Using the camera detector, the non-contact boring system 100 can generate and store a two-dimensional image representing the photon emissions at the bore face 142 in an RGB, CMYK, and/or infrared view.

In some examples, the non-contact boring system 100 is configured to transmit detected light to a spectrum analyzer to decompose emitted and detected light into spectral bands relating to specific molecules or atoms present at the bore face. The spectrum analyzer can function to receive multi-spectral light (e.g., white or blended light) and extract discrete frequencies that correlate to the presence of a particular molecule or atom. In some examples, the non-contact boring system 100 can detect and interpret photons emitted at the bore face using a multi- or hyperspectral imager detector. Using the multi- or hyperspectral imager detector, the non-contact boring system 100 can generate and store a multispectral image or a hyperspectral cube image of the bore face 142 in a multi- or hyperspectral view.

In another variation, the non-contact boring system 100 includes a combination of RGB, CMYK, infrared, multispectral, and hyperspectral detectors to be used in parallel or serially during the boring process. For example, the system can utilize an RGB camera detector in combination with or in sequence with a hyperspectral imager to get a visible light and non-visible light depiction of the bore face 142. The non-contact boring system 100 can then fuse or integrate the respective images into a fuller-spectrum view of the bore face 142, which in turn may reveal more about the underlying chemical composition of the bore face 142.

### Bore Face Composition Mapping Examples

In some examples, a non-contact boring system 100 may access and/or retrieve an initial optical composition model that is located at the boring rig (i.e., at a sensor platform or a controller 150). For example, the initial optical composition model can include a correlation table that matches a detected frequency and amplitude of photons emitted at the bore face 142 with the presence of a particular mineral or geologic feature. In the same or other examples, the initial composition model can correlate a predetermined frequency and amplitude of photons with the presence of crystalline silicon dioxide (SiO₂) at or above a predetermined threshold. In turn, the initial composition model can correlate the presence of crystalline silicon dioxide (SiO₂) and the amplitude or flux of photons received at the detectors with a known type of mineral or geological characteristic, e.g., basalt, limestone, or granite.

In some examples, a non-contact boring system 100 may us the initial optical composition model to transform the frequencies and amplitudes of the transmitted photons into a spatial representation of the geologies, minerals, molecules and/or atoms present at the bore face 142 (bore face map). For example, the images or cubes processed by the detectors can be converted into an analogous depiction of the bore face 142 that indicates regions of particular mineral species, types of rock, or relative resilience or vulnerability of the portions of the bore face 142.

### Examples of Closed-Loop Boring Controls

In some examples, a non-contact boring system 100 may adjust non-contact boring parameters in response to the bore face map. The non-contact boring system 100 can control the physical parameters of the boring rig 101 in real-time or near real-time to adjust or change a non-contact boring temperature, a dwell time on a particular feature or aspect of the bore face 142, a stand-off distance of the boring rig 101 or the non-contact boring element 105, a raster rate of the non-contact boring element 105, a raster pattern of the non-contact boring element 105, or an air pressure/flux at the bore face 142.

For example, a bore face map can indicate a uniform change across the bore face as the boring rig traverses from one type of geology to another, (e.g., a transition from a limestone formation into a granite formation). Given the distinctive spalling characteristic of the different types of rock, the non-contact boring system 100 can then uniformly alter or adjust the aforementioned non-contact boring parameters to ensure boring efficiency through the new geology.

In some examples, the bore face map can indicate a non-uniform feature or aspect of the bore face that is geologically distinct from the rest of the bore face, e.g., a rock or vein having distinct mineral characteristics from the surrounding geology. In response, the non-contact boring system 100 may selectively adjust the aforementioned non-contact boring parameters between the homologous bore face and the anomalous feature detected by the sensor 198. For example, if an area of compressed sand or silt located between two segments of granite is detected at the bore face 142, then the non-contact boring system 100 can selectively alter the temperature, pressure, stand-off distance, and dwell time, in coordination with the raster pattern to optimize boring efficiency. The non-contact boring system 100 can apply higher temperatures and longer dwell times at the granite portions of the bore face 142 and lower temperatures, shorter dwell times, and higher pressures at the sand portions of the bore face 142.

In some examples, the non-contact boring system 100 is configured to convert the bore face map into a coordinate system or other representation of the bore face 142 to match physical locations on the bore face 142 with a controller 150 that determines a longitudinal position, latitudinal position, pitch, yaw, and stand-off distance of the boring-element actuator 107 As the non-contact boring element 105 is steered through the bore face 142 along its raster pattern, the non-contact boring system 100 can then adjust the non-contact boring parameters when the non-contact boring element 105 reaches a region of non-homologous material, e.g., transitioning from granite to sand or vice versa.

### Boring Log Examples

In some examples, the non-contact boring system 100 is configured to generate, at predetermined intervals corresponding to detection and imaging of the bore face 142, a boring log including an understanding of the bore face 142 at the predetermined interval distance along the tunnel. The boring log can include information relating to the position of the chassis 160 or its distance along the tunnel (e.g., measured in meters along the projected tunnel path); the set of boring parameters in use at a time recorded at the predetermined distance along the tunnel; the type of non-contact boring in use at the time recorded; the geologic image of detected frequencies and amplitudes rendered by the detectors; and the compositional image of the bore face 142 showing geological characteristics of the bore face 142 rendered with reference to the initial optical composition model. The non-contact boring system 100 can locally store each boring log on memory at the chassis 160, forming a snapshot of various tunnel conditions at the bore face 142 and providing a record of the boring parameters, detection results, and images rendered.

The non-contact boring system 100 can utilize the boring log to assess and improve the performance of the initial optical composition model through computational or mathematical assessments and feedback to the non-contact boring system 100. For example, the system can transmit the boring log(s) along the umbilical cord 190 to an above-grade location for retrieval and analysis. Performance and accuracy of the initial optical composition model can be reviewed based on statistical or normative benchmarks for interpreting bore face emissions and the subsequent correlation with the geological composition of the bore face. If the boring log is indicative of errors or performance outside of predetermined statistical error ranges, the non-contact boring system 100 can make adjustments to the initial optical composition model to accommodate a new error range. Alternatively, if the boring log is indicative of errors or performance outside of predetermined statistical error ranges, the non-contact boring system 100 can adjust or normalize its boring controls to rectify any issues with the selection or implementation of the set of boring parameters in use at the time of the images.

In some examples, the non-contact boring system 100 is configured to provide the boring log to an onsite detector 199 (e.g., above-grade/above-ground level detector). For example, the boring log can be transmitted to an onsite detector 199 through an umbilical cord 190 data transmission and control channel that connects the chassis 160 to the above-grade facility. The boring log can include a time and location of the detection and imaging of the bore face 142, as well as the non-contact boring parameters in use at the time and location. Further analysis of the ejecta at the onsite detector can provide low latency (e.g., minutes to hours) and higher fidelity characterization of the mineralogy at the bore face for any given time of non-contact boring.

### Examples of Sample Capture and Analysis

In some examples, the non-contact boring system 100 is configured to capture spall samples at an above-grade capture vessel or filter. During the non-contact boring process, the system ejects volumes of gases and small particulate material out of the tunnel as it is ablated from the bore face. The ejecta volume can be related to the length of the tunnel, the temperature and pressure at the bore face 142, the temperature and pressure in the tunnel, and the longitudinal geometry of the tunnel (e.g., turns, rises, drops, angles of ascent or descent).

For example, discrete amounts of ejecta may be captured at predetermined times that correlate to the time and location designated in a boring log. Since the boring log will include a synchronous time stamp at the time of non-contact boring, detection, and image generation, the above-ground ejecta sample and the boring log can be synchronized in time. However, there may be tunnel location anti-correlation as smaller particulates will typically travel faster through the tunnel than larger particulates, and thus arrive at the onsite detector at an earlier time. The captured ejecta that are correlated to any particular time T1 can therefore include some early arrivals from time T2 (smaller particulate), as well as some late arrivals from time T0 (heavier particles), as well as some arrivals that departed the bore face at time T1.

Generally, in order to correct for the time correlation and position anti-correlation, the non-contact boring system 100 is configured to employ a correlation function to normalize the time-of-departure and time-of-arrival discrepancies by retrieving data from the boring log, such as the known non-contact boring parameters, the tunnel length, and the particulate size within certain particulate ranges. The non-contact boring system 100 can then determine appropriate time-of-departures for particulate of given sizes within a sample of collected ejecta.

In one variation, the onsite detector 199 can include a set of filters that selectively capture particulate based on particulate size over a given time interval. Since distinctive particulate sizes will generally correlate to different times-of-departure (for any given set of non-contact boring parameters), the onsite detector 199 can then arrange subsets of filters within the set of filters that correspond to a given time of ejection from the bore face 142. As an example, smaller particulate filters can be moved forward in time (e.g., from time T1 to time T2) to match the later arriving larger particles captured in the larger particulate filters. Conversely, larger particulate filters can be moved backward in time (e.g., from time T1 to time T0) to meet up with the earlier arriving small particulate captured in the small particulate filters. Optimization of the filter sequencing and time-of-departure for each size range of particulate can then yield a subset of filters that correspond to a particular time of departure for multiple particulate sizes, (“spoil sample”) which, in turn, correspond to a state of the bore face as imaged in the boring log.

The spoil sample may be analyzed to determine the mineralogical composition of the spoil sample. For example, the non-contact boring system 100 can remove the spoil sample from a set of filters that correspond to a particular boring log through automated chemical extraction of the particulate or automated chemical decomposition or dissolution of the surrounding filter material. The non-contact boring system 100 can then deliver the separated spoil sample to a set of onsite analyzers that can provide higher fidelity information regarding the composition of the bore face 142 for each particular boring log. For example, the onsite analyzer can include an x-ray diffraction (XRD) analyzer, a laser-induced breakdown spectroscopy (LIBS) analyzer, a laser-induced fluorescence (LIF) analyzer, a Raman spectrometer, or a mass spectrometer. The non-contact boring system 100 can use a subset of the aforementioned analyzers to determine a higher fidelity understanding of the chemical composition of the bore face 142 corresponding to each boring log.

In some examples, the non-contact boring system 100 is configured to compare the spoil sample analysis, the detected image/cube, the geologic image, and the initial optical composition model. If there are differences between the geologic image and the spoil sample analysis, and if the differences exceed a predetermined threshold for uncertainty, then the modeling processor can attribute error and assign error to the non-contact boring system 100 itself or to the initial optical bore composition model.

For example, if the spoil sample indicates the presence of a certain chemical species at the bore face 142, and yet that chemical species was not shown in the geologic image, then the non-contact boring system 100 can categorize this discrepancy as an above-threshold error. Furthermore, the non-contact boring system 100 can categorize any above-threshold errors as being system-based errors or model-based errors. For example, the above-threshold error can be the effect of a system-based error in non-contact boring parameter execution (e.g., too much temperature flux, too little stand-off distance, too great a dwell time); a system-based error in detection of the emitted photons (e.g., faulty, misdirected, or misaligned detector); or a system-based error in the application of the initial composition model in deriving the geologic image (e.g., image processing software fault).

In some examples, the non-contact boring system 100 is configured to distinguish between system-based errors and model-based errors by examining the boring log associated with the spoil sample analysis to ensure proper operation of the system during non-contact boring. For example, if the boring log indicates that the non-contact boring system 100 was performing at or within certain performance thresholds, then the non-contact boring system 100 can attribute any discrepancies between the geologic image and the spoil sample analysis to the initial optical composition model. However, if the boring log indicates that the non-contact boring system 100 was not performing at or within certain performance thresholds, then the non-contact boring system 100 an attribute at least a portion of any discrepancies between the geologic image and the spoil sample analysis to the system performance, although some of the discrepancies may still be attributable to the initial optical composition model.

In some examples, if the non-contact boring system 100 determines that the discrepancies are attributable to the initial optical compositional model, then the non-contact boring system 100 can update the initial optical composition model to account for the discrepancies. The non-contact boring system 100 can store the second optical composition model as a default optical composition model, based upon updated data collection and analysis. The non-contact boring system 100 can then transmit the second optical composition model, via the umbilical cord 190, to the boring rig 101 so that it can continue its non-contact boring, detection, and image processing with the second bore composition model.

### Examples of Sample Shuttle

In some examples, the non-contact boring system 100 is configured to use an on-rig sample collector 195 to collect spoil samples at or near the bore face and a sample shuttle to transmit the collected samples to the onsite detector apparatus for further analysis. The on-rig sample collector 195 may be equipped with a set of filters that are configured to receive spoil samples being ejected rearwards out of the tunnel. Each filter may have variable pore sizes throughout to collect a range of sizes of particulate material.

For example, the system can automatically deploy, seal, and transmit subsequent filters at predetermined time or distance intervals (e.g., every thirty minutes, every two meters). In this variation, each of the filters can be sequentially tagged or stamped using unique identifying materials (genetic barcode polymers, radioactive barcodes) or using a radiofrequency, graphical, optical, or computer-vision readable designator such as a radio frequency identification (RFID) tag, a barcode, or QR code.

Alternatively, each of the filters can be preloaded into the on-rig sample collector being already designated and associated with a particular time or distance, which, in turn, corresponds to the time and distance associated with the boring log (e.g., filter A, time 2 hours, position 4 meters). In some examples, each of the filters can be identified at the on-rig sample collector in near real-time upon the competition of an entry in the boring log, for example through the injection of an inert material, gas, dye, polymer tag, or radioactive tag into the filter that is identified within the corresponding boring log. In this way, the boring log will identify the filter to which it corresponds by referencing the chemical tag embedded in the filter at the bore face by the system.

In some examples, the non-contact boring system 100 is configured to fill the filter with the spoil sample and transmit the filter up the umbilical cord 190 with the associated boring log for analysis. Because the spoil sample was collected at the bore face 142 rather than above grade, the length of the tunnel does not require the time-of-flight corrections that the system can implement during above-grade detection. Furthermore, in this variation, the spoil sample is already linked to a boring log, a geologic image, and a tunnel position, which can reduce or eliminate any uncertainty regarding the correlation between the spoil sample and the geologic image.

In some examples, the non-contact boring system 100 is configured to analyze the spoil sample as described above, and compare the spoil sample analysis, the detected image/cube, the geologic image, and the initial optical composition model. If there are differences between the geologic image and the spoil sample analysis, and if the differences exceed a predetermined threshold for uncertainty, then the modeling processor can attribute error and assign error to the system itself or to the initial optical bore composition model as described above. Further, if the non-contact boring system 100 determines that the discrepancies are attributable to the initial optical compositional model, then the non-contact boring system 100 can update the initial optical composition model to account for the discrepancies. The non-contact boring system 100 can store the second optical composition model as a default optical composition model, based upon updated data collection and analysis. The system can then transmit the second optical composition model, via the umbilical cord 190, to the boring rig 101 so that it can continue its non-contact boring, detection, and image processing with the second bore composition model.

### Examples of Remote Analysis and Modeling: Offsite

In some examples, the non-contact boring system 100 is configured to provide the boring log to an offsite detector 196 (e.g., an above-grade detector). For example, the boring log can be transmitted to an offsite detector 196 from the onsite detector 199, which in turn receives the boring log through an umbilical cord 190 data transmission and control channel that connects the boring rig 101 to the above-grade facility. The boring log can include a time and location of the detection and imaging of the bore face, as well as the non-contact boring parameters in use at the time and location. Further analysis of the ejecta at the offsite detector 196 can provide a high latency (e.g., hours to days) and high-fidelity characterization of the mineralogy at the bore face for any given time of non-contact boring. In general, the analytical fidelity achieved at the offsite detector 196 can be greater than that achieved at the onsite detector 199, which in turn can be greater than that achieved by the sensors 198 on the boring rig 101 at the bore face 142.

As noted above, in an onsite detection implementation in which collection takes place at or above grade, there may be relative time-of-flight differences between particles of different sizes that need to be considered and accounted for in any subsequent analysis. As also noted above, in a bore face collection implementation, the onsite detector 199 can then arrange subsets of filters within the set of filters that correspond to a given time of ejection from the bore face and transmit those time-correlated filters to the offsite detector 196 for further analysis.

The offsite detector 196 may receive the boring logs, receive the collected samples (collected either at the boring rig or at the onsite detector) and analyze the samples to determine a high-fidelity chemical characterization of the bore face 142 at a given time and location. For example, the non-contact boring system 100 can remove the spoil sample from a set of filters that correspond to a particular boring log through automated chemical extraction of the particulate or automated chemical decomposition or dissolution of the surrounding filter material. The system can then deliver the separated spoil sample to a set of onsite analyzers that can provide higher fidelity information regarding the composition of the bore face 142 for each particular boring log. For example, the offsite analyzer can include an x-ray diffraction (XRD) analyzer, a laser-induced breakdown spectroscopy (LIBS) analyzer, a laser-induced fluorescence (LIF) analyzer, a Raman spectrometer, a mass spectrometer, a scanning electron microscope, energy-dispersive x-ray spectroscopy, an x-ray fluorescence analyzer, an ASTM analyzer, a petrographic microscope, or thin section analyzer. The non-contact boring system 100 can use a subset of the aforementioned analyzers to determine a higher fidelity understanding of the chemical composition of the bore face 142 corresponding to each boring log.

In some examples, the non-contact boring system 100 is configured to save each spoil sample analysis corresponding to each boring log and transmit the spoil sample analysis and corresponding boring log to a modeling processor at the offsite detector. The modeling processor can receive the spoil sample analysis and corresponding boring log to improve the initial optical composition model.

In some examples, the non-contact boring system 100 is configured to compare the spoil sample analysis, the detected image/cube, the geologic image, and the initial optical composition model. If there are differences between the geologic image and the spoil sample analysis, and if the differences exceed a predetermined threshold for uncertainty, then the modeling processor can attribute error and assign error to the system itself or to the initial optical bore composition model. Additionally, at the offsite detector 196, the non-contact boring system 100 may improve the time-of-flight characterization used at the onsite detector 199 for normalizing the spoil sample collection of various particulate sizes.

As noted above, if the spoil sample indicates the presence of a certain chemical species at the bore face 142, and yet that chemical species was not shown in the geologic image, then the non-contact boring system 100 can categorize this discrepancy as an above-threshold error. Furthermore, the non-contact boring system 100 can categorize any above-threshold errors as being system-based errors or model-based errors. For example, the above-threshold error can be the effect of a system-based error in non-contact boring parameter execution (e.g., too much temperature flux, too little stand-off distance, too great a dwell time); or a system-based error in detection of the emitted photons (e.g., faulty, misdirected, or misaligned detector); or a system-based error in the application of the optical composition model in deriving the geologic image (e.g., image processing software fault).

In some examples, the non-contact boring system 100 is configured to distinguish between system-based errors and model-based errors by examining the boring log associated with the spoil sample analysis to ensure proper operation of the non-contact boring system 100 during non-contact boring. For example, if the boring log indicates that the non-contact boring system 100 was performing at or within certain performance thresholds, then the non-contact boring system 100 can attribute any discrepancies between the geologic image and the spoil sample analysis to the initial optical composition model. However, if the boring log indicates that the system was not performing at or within certain performance thresholds, then the non-contact boring system 100 can attribute at least a portion of any discrepancies between the geologic image and the spoil sample analysis to the system performance, although some of the discrepancies may still be attributable to the initial optical composition model.

In some examples, if the non-contact boring system 100 determines that the discrepancies are attributable to the initial optical compositional model, then the non-contact boring system 100 can update the initial optical composition model or the second optical composition model to account for the discrepancies. The non-contact boring system 100 can store the third optical composition model as a default optical composition model, based upon updated data collection and analysis. The non-contact boring system 100 can then transmit the third optical composition model to the onsite detector 199 to replace the second optical composition model. The onsite detector 199 can then transmit the third optical composition model, via the umbilical cord 190, to the boring rig 101 so that it can continue its non-contact boring, detection, and image processing with the third bore composition model.

In some examples, an onsite detector 199 may receive the third optical composition model from the offsite detector 196, adjusting received geologic images in the boring logs received from the boring rig 101, and fusing the adjusted geologic images into a geology map of the tunnel. The onsite detector 199 can include a three-dimensional modeling module that can assemble and orient the geologic images in sequence with the known or estimated trajectory of the boring rig 101 through the tunnel. Generally, the non-contact boring system 100 renders the geologic images at predetermined distances along the length of the tunnel, such that a resulting sequential assembly is a sequence of geologic image slices of bore face representations along the tunnel path.

In one variation, the non-contact boring system 100 can interpolate the geology of the spaces between the sequential geologic images using a set of interpolation rules that estimate a next pixel (geologic) value based upon neighboring pixels. The set of interpolation rules can be derived from the third optical composition model. Alternatively, the set of interpolation rules can be derived from a standard geological model based upon expected geological characteristics of materials at certain depths below grade (i.e., based upon general location such as mountain, riverbed, beachside, or bedrock). In another alternative, the set of interpolation rules can be derived from additional geologic images captured by the non-contact boring system 100 at the bore face 142 that occurred between spoil sample intervals (e.g., bore face image capture every 0.1 meters, bore face spoil collection every 1 meter).

In another variation of the non-contact boring system 100, the resulting geology map of the tunnel can be saved and transmitted to other boring rigs operating in adjacent or similar geologies to provide the other boring rigs with an advanced understanding of the underlying geology. Alternatively, the geology map can be stored for access and use by other entities designing, building, excavating, mining, or otherwise improving the land at or near the tunnel site.

Generally, a completed tunnel can include a liner or insert that defines an interior surface and finish of the tunnel. However, in instances in which the liner is either undesirable or unnecessary, the rock itself can suffice on its own as a finished interior surface that is suitable for containing and protecting the assets within (e.g., conduits, sensors, etc.). Therefore, in another variation, the non-contact boring system 100 can generate a three-dimensional spatial and surface finish map of the bored tunnel by fusing data acquired by the sensors 198 (e.g., a camera or a camera cooperating with a lighting system and a ranging sensor such as LIDAR). In response to the spatial and surface map, the non-contact boring system 100 is configured to render an image or set of images characterizing or qualifying the tunnel as suitable for receipt of the assets noted above. Alternatively, the non-contact boring system 100 is configured to render an image or set of images characterizing or qualifying the tunnel as unsuitable for direct receipt of the assets, from which the need for an additional liner or insert can be inferred. For example, some types of geology might yield hard and smooth bored surfaces, for which an interior liner may not be necessary. Other types of geology might yield softer or more jagged bored surfaces, in which case an interior liner may be desirable. Moreover, a single tunnel can include both types of geologies, as noted above, and therefore the non-contact boring system 100 is configured to determine those section(s) of the tunnel for which an interior liner may be desirable or necessary.

### Trenching Method Examples

As noted above, a non-contact boring system 100 may be used for trenching, which is one example of boring that forms a trench (i.e., a long and narrow excavation in the ground). Unlike a tunnel, which is another form of a bore, a trench is open and provides more equipment access.

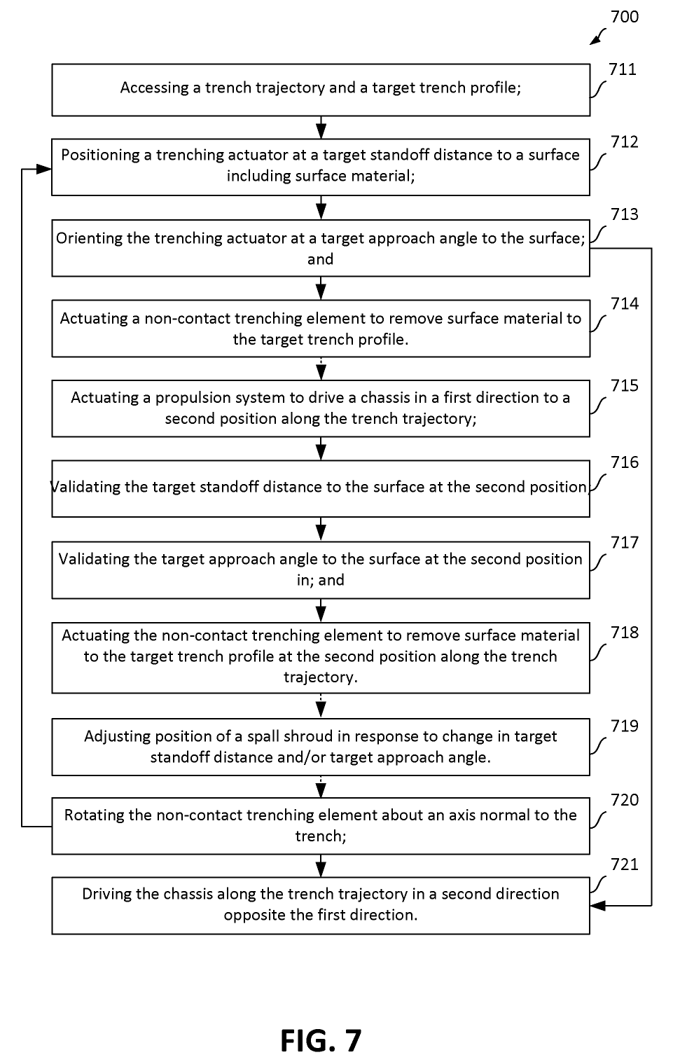

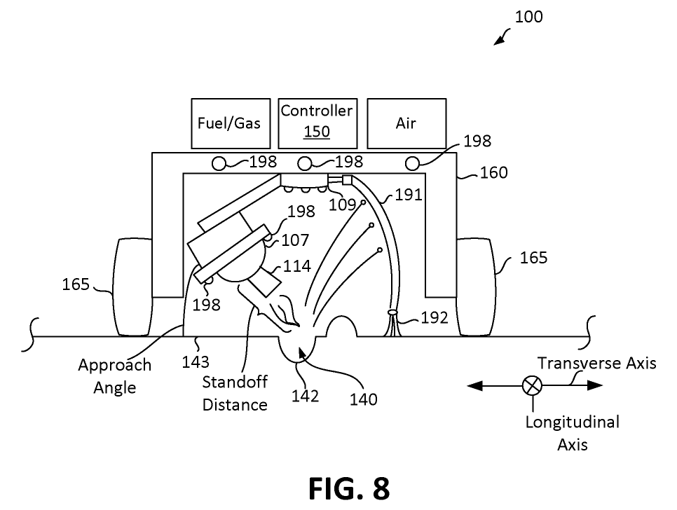

FIG. 7 illustrates a process flowchart corresponding to method 700 of non-contact trenching using a non-contact trench system 100, in accordance with some examples. Various aspects and features of the non-contact boing system 100 are described above. Additional aspects are described below with reference to FIG. 8.

Returning to FIG. 7, method 700 may comprise (block 711) accessing a trench trajectory and a target trench profile. This operation may be performed by the controller 150. Method 700 may proceed with (block 712) positioning a trenching actuator at a target standoff distance to a surface including surface material. Again, this operation may be performed by the controller 150. Method 700 may proceed with (block 713) by the controller 150, orienting the trenching actuator at a target approach angle to the surface and (block 714), by the controller, actuating a non-contact trenching element to remove surface material to the target trench profile. Method 700 can further comprise (block 715) by the controller, actuating a propulsion system to drive a chassis in a first direction to a second position along the trench trajectory, (block 716) by the controller, validating the target standoff distance to the surface at the second position; (block 717) by the controller, validating the target approach angle to the surface at the second position; and (block 718) by the controller, actuating the non-contact trenching element to remove surface material to the target trench profile at the second position along the trench trajectory.

In some examples, method 700 can also include (block 719) by the controller, adjusting the position of a spall shroud in response to a change in target standoff distance and/or target approach angle such that the ejected spall is contained in a target area adjacent to the trench. In the same or other examples, method 700 can also include (block 720) by the controller, rotating the non-contact trenching element about an axis normal to the trench; (block 712) positioning the trenching actuator at the target standoff distance to the surface and (block 713) positioning the trenching actuator at the target approach angle to the surface. In some examples, method 700 can further include (block 721) by the controller, driving the chassis along the trench trajectory in a second direction opposite the first direction.

### Trenching System Examples

As shown in FIG. 8, a non-contact boring system 100 (for trenching) comprises a chassis 160 and a propulsion subsystem 165 arranged with the chassis 160 and configured to advance the chassis 160 in a first direction along a trench trajectory and retract the chassis 160 in a second direction opposite the first direction. The non-contact boring system 100 also comprises a non-contact boring element 114 (which may be also referred to as a non-contact trenching element) connected to the chassis 160 and configured to operate in response to a set of trenching parameters. Furthermore, the non-contact boring system 100 may comprise a boring-element actuator 107 (which may be also referred to as a boring actuator) coupling the non-contact boring element 114 to the chassis 160 and configured to position the non-contact boring element 114 at a target standoff distance and orient the non-contact boring element 114 at a target approach angle. In some examples, the non-contact boring system 100 comprises a set of sensors 198 (e.g., depth sensors) configured to measure a standoff distance between the chassis 160 and the surface and between the chassis 160 and the interior surface of the trench. The non-contact boring system 100 can also include a controller 150 connected to the propulsion subsystem 165, the non-contact boring element 114, and the set of sensors 198 (e.g., depth sensors). The controller 150 can be configured to actuate the propulsion subsystem 165, the non-contact boring element 114, and the set of sensors 198 (e.g., depth sensors) in response to the set of depth sensors measuring: the standoff distance and/or approach angle of the chassis 160 relative to the surface and/or interior surface of the trench.

As shown in FIG. 8, a non-contact boring system 100 can further include a spall shroud 191 coupled to the chassis 160 and configured to retain and direct spall fragments to a location adjacent to the trench during and/or subsequent to non-contact trenching.

In some examples, shown in FIG. 8, a non-contact boring system 100 can further include a central rotor 109 connected to the controller 150 and about which the non-contact boring element 114 and the boring-element actuator 107 can rotate about an axis normal to the surface. The controller 150 can actuate the central rotor 109 to: adjust the relative positions of the non-contact boring element 114 and the spall shroud 191 about a longitudinal axis of the trench (e.g., a transverse configuration); and/or adjust the relative positions of the non-contact boring element 114 and the spall shroud 191 along a longitudinal axis of the trench (e.g., a longitudinal configuration). Referring to FIG. 8, in some examples, a non-contact boring system 100 can further include a flexible skirt 192 connected to the spall shroud 191 and configured to adjust to changes in terrain along the trench trajectory.

### Trenching Application Aspects

In some examples, a non-contact boring system 100 is configured to autonomously or semi-autonomously trench or excavate material from a surface with non-contact trenching effectors. Examples of non-contact boring element 114 (which may be referred to as a non-contact trenching element) can include one or more of a plasma torch, a jet engine, a flame jet, directed electromagnetic energy, a water (or other liquid) jet, or a pressured fluid/gas stream. The non-contact boring system 100 may be configured to traverse a predetermined trench trajectory via autonomous navigation (e.g., via GPS/5G/wireless transceivers, waypoint finding, etc.), or via remote steering and navigation from an operator terminal.

For example, a non-contact boring system 100 may be configured to (a) autonomously or semi-autonomously position itself relative to a desired trench trajectory; (b) arrange and orient a non-contact boring element 114 at a target approach angle and a target standoff distance; (c) actuate the non-contact boring element 114 to automatically excavate the trench; (d) implement closed-loop controls to maintain the target standoff distance and target approach angle in response to changes in surface material (e.g., changes from sand to granite); and (e) collect and deposit ejected spall material at a location adjacent the trench for ease of refill (if desired) upon completion of the trench and insertion of the pipe or cable therein.

In some examples, a non-contact boring system 100 can include a controller 150 and a set of sensors 198 (e.g., a depth sensor or multiple depth sensors) configured to: (a) continuously or intermittently measure a standoff distance between the non-contact boring element 114 and the surface 143; and/or (b) measure a distance between the sensors and a set of points in the bore face 142 (e.g., at the bottom of the trench). As further described, in response to the measurements from the depth sensor(s), the controller 150 can be configured to: adjust a standoff distance to the surface 143 and/or the bore face 142 (which may be also referred to as a trenching surface); adjust an approach angle of the non-contact boring element 114 relative to the surface 143; adjust a set of trenching parameters to improve trenching performance (e.g., in response to high or low yield regions of excavation); and/or rearrange or reorient non-contact boring system about the trench trajectory to improve the depth, symmetry, or shape of the trench.

### Trenching Initialization

Generally, to initiate a trenching operation, a non-contact boring system 100 may be located at a selected position along a trench trajectory. For example, the non-contact boring system 100 can be arranged (automatically or manually) at an initial point of a trenching operation and oriented such that the controller 150 can direct the propulsion subsystem 165 along a set or variable trench trajectory. With the non-contact boring system 100 located at the initial point and the non-contact boring element 114 adjacent to the surface (e.g., ground), the controller can: implement methods and techniques described below to: drive the non-contact boring element 114 to a target standoff distance and target approach angle relative to the surface; actuate the non-contact boring element 114 to remove material from the surface; and actuate the propulsion subsystem 165 to advance and/or retract the trenching rig to a second position at the target standoff distance and/or target approach angle. As described below, the controller 150 can implement closed-loop controls to maintain the target standoff distance and target approach angle and to autonomously or semi-autonomously steer or navigate the trenching rig along the trench trajectory.

In some examples, the controller 150 can cooperatively control both the boring-element actuator 107 and the propulsion subsystem 165 to drive the chassis 160 along the trench trajectory in response to a trench depth and trench profile determined in response to one or more depth sensor readings received at the controller 150. Additionally, the controller 150 can cooperatively control the boring-element actuator 107 and the propulsion subsystem 165 to maintain a target standoff distance to the surface 143 and a target approach angle to the bore face 142 by monitoring a trench profile and, if necessary, adjusting a position of the boring-element actuator 107 and/or the chassis 160 relative to the trench. Furthermore, the controller 150 can implement closed-loop controls to autonomously or semi-autonomously drive the chassis 160 along the trench trajectory while autonomously or semi-autonomously maintaining a target trench profile.

### Depth Sensors and Standoff Distance

Referring to FIG. 8, in some examples, a non-contact boring system 100 comprises a set of sensors 198 (e.g., one or more depth sensors) arranged near the bottom face of non-contact boring system 100 near the non-contact boring element 114. The depth sensor can include a contact-based depth sensor including: a contact probe; a linear actuator configured to extend the contact probe toward the surface 143 and/or bore face 142 and to retract the contact probe, such as into a thermally shielded housing; and an encoder or other sensor configured to track the length of the contact probe extending from the bottom face of non-contact boring system.

In some examples, the controller 150 can intermittently trigger the depth sensor to execute a standoff measurement cycle, such as once per minute. During a standoff measurement cycle, the controller 150 can: direct the linear actuator to extend the contact probe out of the housing; read a length measurement from the sensor once resistance on (or current draw from) the actuator reaches a threshold resistance (or threshold stall current); return this length measurement to the controller 150; and trigger the linear actuator to retract the contact probe back into the housing.

Furthermore, when the contact probe is extended out of the depth sensor housing during a standoff measurement cycle, the controller 150 can adjust a trenching parameter (e.g., air flow, fuel flow, gas flow, electrical power) of the non-contact boring element 114 to reduce the surface temperature at the surface 143 and thus reduce thermal shock and/or heat-induced warpage of the contact probe. The controller 150 can subsequently readjust or modify the trenching parameter of the non-contact boring element 114 to resume trenching by increasing the surface temperature at the surface 143 once the linear actuator returns the contact probe to the housing.

Upon receipt of a length measurement from the depth sensor, the controller 150 can store this length measurement as a current standoff distance. The controller 150 can also: calculate a boring-element actuator 107 reset distance based on the current longitudinal position of the boring-element actuator 107 and the current position of the chassis 160; reset the boring-element actuator 107 to a home position over a reset distance; and actuate the propulsion subsystem 165 to steer the non-contact boring system 100 laterally (e.g., orthogonal to the trench trajectory) by a sum of the boring-element actuator 107 reset distance and a difference between the current standoff distance and a current target standoff distance, thereby locating the non-contact boring element 114 at the target standoff distance.

In some examples, the contact probe can be spring-loaded on the linear actuator and/or the depth sensor housing can be spring-loaded on the chassis 160. During a standoff measurement cycle, the controller 150 triggers the depth sensor to extend the contact probe to the current target standoff distance. If the contact probe fails to meet resistance at this target standoff distance, the controller 150: retracts the boring-element actuator 107 to the home position; and advances the boring-element actuator 107 toward the trench until the contact probe meets resistance (i.e., contacts the surface 143), thereby setting the non-contact boring element 114 at the target standoff distance; records a bore distance since a last standoff measurement cycle based on the distance traversed by the boring-element actuator 107; and then triggers the depth sensor to retract the contact probe.

In some examples, after recording a standoff distance and resetting the non-contact boring element 114 to the target standoff distance during a standoff measurement cycle, the controller 150 can: implement dead-reckoning techniques to estimate the current standoff distance as a function of the last measured standoff distance, trenching parameters associated with the non-contact boring element 114; and implement closed-loop controls to adjust the boring-element actuator 107 position and/or advance and/or steer the propulsion subsystem 165 to maintain the estimated current standoff distance at the target standoff distance. The controller 150 can then trigger a next standoff measurement cycle once the estimated trenching distance completed by the non-contact boring system 100 exceeds a threshold distance (e.g., one inch) or after a threshold duration of time.

In some examples, the non-contact boring element 114 is a plasma torch. In this variation, the contact probe can be electrically shielded, and the non-contact boring system 100 can regularly or continuously read a standoff distance from the depth sensor. For example, the contact probe can include a stainless steel or low-alloy steel shaft and can be driven to a reference voltage – such as to the same voltage as the cathode in the plasma torch or to the average voltage of the cathode and anode in the plasma torch – thereby creating an electric field around the contact probe that repels charged plasma, gas, and spall flowing between the plasma torch and the surface 143.

Therefore, the controller 150 can drive the contact probe to maintain continuous or substantially continuous contact with the surface 143, and the controller 150 can drive the boring-element actuator 107 and/or steer the propulsion subsystem 165 to maintain a target standoff distance between the plasma torch and the surface 143 based on a standard distance read and output by the depth sensor.

Alternatively, the depth sensor can regularly or continuously oscillate the contact probe toward and away from the surface 143 during operation, such as: by partially retracting the contact probe to enable fracture and spallation of rock at the surface 143 ahead of the contact probe or by fully retracting the contact probe into a thermally-shielded housing within the chassis to enable the contact probe to cool; and then advancing the contact probe forward and into contact with the surface 143. Once the contract probe contacts the surface 143, the controller 150 can determine or calculate a current standoff distance as described above.

The controller 150 can also regularly drive the boring-element actuator 107 and/or the propulsion subsystem 165 to maintain a target standoff distance between the non-contact boring element 114 and the surface 143 based on a measured length of the contact probe upon last contact with the surface 143. Furthermore, the controller 150 can implement dead-reckoning techniques to estimate the current standoff distance, adjust the boring-element actuator 107 positions, and/or steer the propulsion subsystem 165 to maintain this estimated current standoff distance at the target standoff distance and adjust trenching parameters in time intervals between consecutive standoff distance measurements with the contact probe.

In some examples, a non-contact boring system 100 comprises one or more single-point contactless depth sensors. For example, a non-contact boring system 100 comprises a thermally shielded sensor housing; a thermally shielded shutter arranged across an opening in the shutter housing; and a single-point depth sensor arranged in the housing behind the shutter, such as a radar-based depth sensor (e.g., a millimeter-wave radar sensor), an infrared sensor, an ultrasonic sensor, a laser (e.g., LIDAR, time of flight) sensor, etcetera.

Throughout operation, the controller 150 can: open the shutter; sample the depth sensor to capture a depth measurement at a point on the surface 143 and/or bore face 142; and then close the shutter to shield the depth sensor from excess heat. For example, the controller 150 can intermittently trigger the depth sensor to execute a standoff measurement cycle, such as once per minute as described above.

In some examples, a non-contact boring system 100 comprises: a thermally shielded sensor housing; a thermally shielded shutter arranged across an opening in the shutter housing; and a multi-point depth sensor arranged in the housing behind the shutter, such as a radar-based depth sensor, a multi-point millimeter-wave radar sensor, a 2D depth camera, or a 3D LIDAR camera. In this implementation, the controller 150 can: open the shutter and sample the depth sensor during a standoff measurement cycle; derive a bore face profile from an output of the depth sensor during this standoff measurement cycle; and adjust the operation of the non-contact boring system 100 accordingly, as described herein.

In some examples, a non-contact boring system 100 comprises a temperature sensor within the sensor housing. During operation, the controller 150 can: regularly sample this temperature sensor; open the shutter and read standoff measurements from the depth sensor when the temperature in the housing is below an operating temperature range; and close the shutter and cease standoff measurements when the temperature in the housing is above the operating temperature range.

In some examples, a non-contact boring system 100 comprises a set of depth sensors including a combination of contact sensors and non-contact sensors. Furthermore, in these or other examples, the non-contact boring system 100 can include a non-contact depth sensor that includes subcomponents or functionality (e.g., an optical camera paired with a LIDAR range finder) to provide optical or topological data regarding a temperature profile or topological profile of the surface 143 and/or bore face 142.

In some examples, a non-contact boring system 100 comprises a set of non-contact depth sensors arranged at a trailing edge of the chassis 160 and oriented rearward toward the trench. The set of non-contact depth sensors can be arranged outside of the primary heating zone of the non-contact boring system 100 and thus not require special shielding from the non-contact boring element 114. Therefore, in these or other examples, the set of non-contact depth sensors can continuously monitor the depth, shape, and symmetry of a portion of the trench subsequent to the non-contact boring system 100 trenching the portion of the trench. Additionally, or alternatively, a set of depth sensors can also be arranged on the leading edge of the chassis 160.

### Trench Profiling and Closed-Loop Controls

In some examples, a non-contact boring system 100 is configured to regularly or intermittently measure a distance from each depth sensor to the bore face 142. The controller 150 then: fuses or integrates the multiple depth measurements from the depth sensors to calculate or determine a profile of the trench (e.g., trench depth, trench symmetry, trench curvature). In response to the trench profile, the controller 150 then: implements closed loop controls as described herein to arrange the non-contact boring element 114 and/or chassis 160 at a target standoff distance and a target approach angle. Additionally, or alternatively, the controller 150 can be configured to repeatedly traverse or trench along a portion of the trench trajectory (e.g., iteratively remove material from the surface to align with a target trench profile).

In some examples, the controller 150 can also tilt (e.g., pitch, yaw) the boring-element actuator 107 and/or steer the chassis 160 relative to the trench to adjust or maintain a target approach angle. Generally, a lower approach angle (e.g., closer to parallel to the surface 143) can result in a relatively wider and shallower trench profile. Conversely, a higher approach angle (e.g., closer to orthogonal to the surface 143) can result in a relatively narrower and deeper trench profile.

In some examples, a non-contact boring system 100 comprises multiple depth sensors, each configured to extend from the bottom face of the non-contact boring system 100 and to measure a distance from its position on the bottom face of the non-contact boring system 100 to a corresponding position on the surface 143 and/or bore face 142 to generate a multidimensional characterization of the surface 143 and/or the bore face 142. Based upon the multidimensional characterization of the bore face 142, the controller 150 can interpolate a topographical profile of the bore face 142 including the trench depth, trench width, trench symmetry, and trench curvature (e.g., degree of convexity).

For example, the controller 150 can: receive or access a set of depth measurements from the set of depth sensors; generate a trench profile of the trench indicating a trench depth, trench width, trench symmetry, and trench curvature; and implement closed-loop controls to align the trench profile with a target trench profile. Therefore, if the trench profile indicates that the trench is shallow thereby indicating low yield in non-contact trenching, then the controller 150 can: pause and/or raster the non-contact boring element 114 over the region of low yield to increase trench depth to match that of the target trench profile. Similarly, if the trench profile indicates that the trench is too narrow, the controller 150 can: adjust the approach angle of the non-contact boring element 114 to decrease the approach angle of the non-contact boring element 114 and thus remove more material from the periphery of the trench.

Additionally, or alternatively, in implementing closed-loop controls to achieve the target trench profile, the controller 150 can: adjust one or more trenching parameters to adjust the output of the non-contact boring element 114. For example, if the trench profile calculated by the controller 150 is shallower than the target trench profile thereby indicating low-yield material, the controller 150 can: adjust a target standoff distance to increase material yield; alter or raster a target approach angle to apply non-contact trenching effects across a different or wider range of approach angles; and/or adjust a set of trenching parameters to increase heat flux and/or pressure at the low yield region. The controller 150 can implement the foregoing closed-loop controls in sequence or in parallel while continuing to image and regenerate the trench profile via the set of depth sensors.

### Spall Control and Placement Examples

As shown in FIG. 8, a non-contact boring system 100 can be arranged about the trench across a transverse axis such that the non-contact boring element 114 impinges upon the surface 143 along the transverse axis. In operation, the ejection of spall from the non-contact trenching may be emitted in a direction opposite the non-contact boring element 114. Accordingly, in some examples, a non-contact boring system 100 can further include a spall shroud 191 coupled to the chassis 160 and configured to retain and direct spall fragments to a location adjacent to the trench during and/or subsequent to non-contact trenching. The spall shroud 191 can be shaped, baffled, contoured, or otherwise configured to deflect or reflect spall ejecta to a location adjacent to the trench.

For example, as shown in FIG. 8, a non-contact boring system 100 can be arranged about the bore 140 (the trench in this example) such that the non-contact boring element 114 impinges upon the surface 143 at a target standoff distance and target approach angle along the transverse axis. As such, spall ejecta may be exhausted from the trench along the same transverse axis at which point it is reflected off the spall shroud 191 and returns to the surface 143 for ease of replacement once the trench is filled (e.g., once a pipe or cable is arranged in the trench). The spall shroud 191 can be contoured or shaped, either statically or dynamically, to receive and reflect spall ejecta to a desired location alongside the trench.

For example, the spall shroud 191 can be generally concave and parabolic along its interior surface such that the ejected spall is redirected to a particular location (e.g., at or near a focal point of the parabolic shape). Alternatively, the spall shroud 191 can be generally convex, triangular, or dual parabolic along its interior surface such that the ejected spall is redirected to either side of the spall shroud 191. In yet another alternative, the spall shroud 191 can be dynamically reshaped or recontoured by the controller 150 during operation in order to adjust or modify the placement of the ejected spall. For example, the spall shroud 191 can be generally concave in trenching operations in a transverse configuration and generally convex in trenching operations in a longitudinal configuration, as described in more detail below.

In some examples, a non-contact boring system 100 comprises a flexible skirt 192 connected to the spall shroud 191 and configured to adjust to changes in terrain along the trench trajectory. For example, the flexible skirt 192 can include a rubberized material that is readily deformable such that it can maintain contact with the surface 143 as the chassis 160 advances over uneven terrain, rocks, roots, etcetera along the trench trajectory. Alternatively, the flexible skirt 192 can include a series of separately deformable members that are arranged, either overlapping or non-overlapping) to permit discrete rises or dips in elevation along the length of the flexible skirt 192 while proceeding along the trench trajectory. In another alternative configuration, the flexible skirt 192 can be selectively retractable into the spall shroud 191 in response to the controller 150 directing a change in: the position of the non-contact boring element 114, boring-element actuator 107, and the spall shroud 191; and/or the configuration of the non-contact boring system 100 between transverse and longitudinal trenching.

In some examples, a non-contact boring system 100 comprises a central rotor 109 connected to the controller 150 about which the non-contact boring element 114 and the boring-element actuator 107 can rotate about an axis normal to the surface. For example, the central rotor 109 can function to rotate the non-contact boring element 114 and the boring-element actuator 107 from the first side of the trench to an opposing second side of the trench while also rotating the spall shroud 191 and/or flexible skirt 192 from the second side of the trench to the first side of the trench.

Accordingly, in operation the controller 150 can: trench a first section of a trench in a first transverse configuration and in a first direction in which the non-contact boring element 114 and the boring-element actuator 107 are arranged on the first side of the trench and the spall shroud 191 and/or flexible skirt 192 is arranged on the second side of the trench opposite to the first side of the trench; upon completion of the first section of the trench, actuate the central rotor 109 to rotate the non-contact boring element 114 and the boring-element actuator 107 from a first side of the trench to the opposing second side of the trench and rotate the spall shroud 191 and/or flexible skirt 192 from the second side of the trench to the first side of the trench; actuate the non-contact trenching element; and actuate the propulsion subsystem 165 to begin propelling the chassis 160 in a second direction opposite the first direction. Accordingly, the non-contact boring system 100 can be configured to trench fore and aft along any portion or segment of the trench trajectory from opposing transverse configurations such that the trench is substantially symmetrical and such that the ejected spall is removed and arranged on opposing sides of the trench upon completion.

In some examples, the controller 150 can actuate the central rotor 109 to: rotate the non-contact boring element 114 and the boring-element actuator 107 from the first side of the trench along the longitudinal axis of the trench while also rotating the spall shroud 191 from the second side of the trench to the longitudinal axis of the trench. In some examples, the non-contact boring element 114 can be rotated such that it is disposed in the direction of travel of the non-contact boring system 100 and the spall shroud 191 is rotated such that it is disposed trailing the direction of travel of the non-contact boring system 100. Additionally, or alternatively, in a longitudinal configuration, the spall shroud 191 can include a set of baffles and/or a generally convex, triangular, or dual parabolic internal surface that directs ejected spall to either side of the trench.

In the same or other examples, the controller 150 can: trench the first section of a trench in a first longitudinal configuration and in a first direction in which the non-contact boring element 114 and the boring-element actuator 107 are arranged on a leading edge of the trench and the spall shroud 191 is arranged on the trailing side of the trench; upon completion of the first section of the trench, actuate the central rotor 109 to rotate the non-contact boring element 114 and the boring-element actuator 107 from a leading edge of the trench to the trailing edge of the trench and rotate the spall shroud 191 from the trailing edge of the trench to the leading edge of the trench; actuate the non-contact trenching element; and actuate the propulsion subsystem 165 to begin propelling the chassis 160 in a second direction opposite the first direction such that the formerly trailing edge of non-contact boring system is the leading edge. As noted above, a non-contact boring system 100 can be configured to trench fore and aft along any portion or segment of the trench trajectory from opposing longitudinal configurations such that the trench is substantially symmetrical and such that the ejected spall is removed and arranged on opposing sides of the trench upon completion.

In some examples, a non-contact boring system 100 comprises a set of non-contact depth sensors arranged on an exterior surface of the chassis 160, for example, both the leading and trailing edge of the non-contact boring system 100. Operating in this example configuration, the set of non-contact depth sensors can continuously or substantially continuously measure and transmit depth measurements to the controller 150 for interpolation and generation of a trailing trench profile. The controller can then: access the target trench profile; register the trailing trench profile to the target trench profile; and, in response to any deviation in the trailing trench profile and the target trench profile, implement the techniques and methods above to reorient and redirect non-contact boring system toward the trailing trench section. The set of non-contact depth sensors can continuously or substantially continuously measure and transmit depth measurements as the non-contact boring system 100 retraces its prior travel and the controller 150 can further continue to update the trailing trench profile.

### Vertical Non-Contact Boring System Examples

In addition to boring underground tunnels and trenches (described above), a non-contact boring system 100 may be used for vertical non-contact boring, e.g., forming vertical shafts. For purposes of this disclosure, the term “vertical” is defined as a direction that is within 45°, within 30°, or even within 15° from the gravitational vertical.

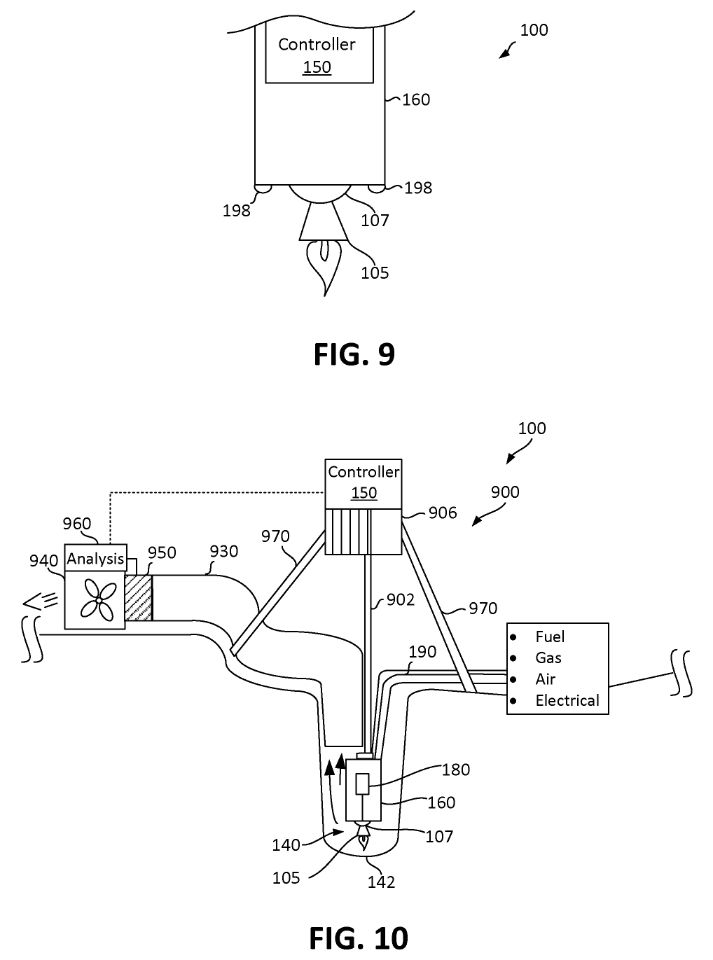

FIGS. 9 and 10 are schematic illustrations of a non-contact boring system 100 for vertical non-contact boring. In some examples, the non-contact boring system 100 comprises a chassis 160, a non-contact boring element 105, and a boring-element actuator 107 connecting the non-contact boring element 105 to the chassis 160. The non-contact boring system 100 can also comprise a surface rig 900 arranged on a surface and comprising (a) a connector 902 connecting the surface rig 900 to the chassis 160, and (b) a driver 906 coupled to the connector 902 and configured to position the chassis 160 along an axis. For example, the driver 906 may be a linear actuator, while the connector 902 may be a rod, pipe, or some other rigid structure that is coupled to both the driver 906 and the chassis 160. The surface rig 900 may also comprise an umbilical cord 190 arranged between the chassis 160 and the surface and configured to house a set of boring input lines. Various aspects of the umbilical cord 190 are described above. The surface rig 900 may also comprise an additional extensible coupling 930 arranged between the chassis 160 and the surface rig 900 and configured to transfer boring ejecta from a bore face 142 to the surface. Finally, the surface rig 900 may comprise an exhaust 940 connected to the additional extensible coupling 930 and configured to draw boring ejecta through the additional extensible coupling 930.

As described above, the non-contact boring system 100 may also comprise a controller 150 connected to the non-contact boring element 105, the boring-element actuator 107, the driver 906. and the exhaust. The controller 150 may be configured to (a) direct the driver 906 to position the non-contact boring element 105 at a target standoff distance, (b) monitor a set of boring parameters associated with the non-contact boring element 105, (c) direct the exhaust 940 to draw boring ejecta through the second extensible coupling at a target exhaust rate, and (d) characterize a boring rate in response to a spall size of the spall generated at the bore face 142 during boring operations.

In some examples, the non-contact boring system 100 comprises a filter 950 arranged with the additional extensible coupling 930 to collect boring ejecta; and an analyzer 960 connected to the controller 150 and configured to determine a characteristic of a bore face material based upon a composition of the boring ejecta and measure the spall size of the spall generated at the bore face 142 during operation.

In some examples, the non-contact boring system 100 comprises a set of optical sensors connected to the controller 150 and arranged on the chassis 160 facing the bore face 142. The controller 150 can be configured to receive an image from the set of optical sensors and determine a spall size of the spall generated at the bore face 142 during operation in response to a pixel analysis of the image.

### Vertical Non-Contact Boring Method Examples

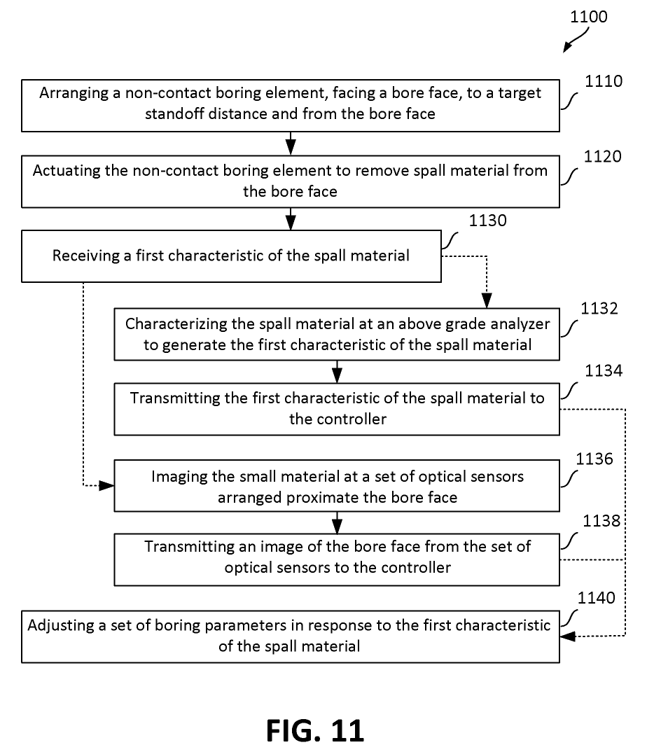

FIG. 11 is a process flowchart corresponding to method 1100 for vertical non-contact boring using a non-contact boring system 100, in accordance with some examples. The method 1100 may comprise (block 1110) at the first time by a controller 150, arranging a non-contact boring element 114, facing a bore face 142, to a target standoff distance and from the bore face 142. The method 1100 may comprise (block 1120) by the controller 150, actuating the non-contact boring element 114 to remove spall material from the bore face 142. Method 1100 may comprise (block 1130) by the controller 150, receiving the first characteristic of the spall material, and (block 1140) by the controller 150, adjusting a set of boring parameters in response to the first characteristic of the spall material. As shown in FIG. 11, method 1100 can include (block 1132) characterizing the spall material at an above-grade analyzer to generate the first characteristic of the spall material and (block 1134) transmitting the first characteristic of the spall material to the controller in Block 1134. Additionally, or alternatively, the method 1100 can include (block 1136) imaging the spall material at a set of optical sensors arranged proximate the bore face and (block 1138) transmitting an image of the bore face from the set of optical sensors to the controller 150.

In some examples, method 1100 includes, by the controller 150, maintaining or adjusting a negative pressure applied by an exhaust at the surface in response to the first characteristic of the spall material. In the same or other examples, method 1100 can further include, by the controller, maintaining or adjusting a set of boring parameters and/or maintaining or adjusting a negative pressure applied by an exhaust at the surface in response to a predicted bore face geology based upon the first characteristic of the spall material.

### Vertical Boring Application Examples

In some (vertical boring) examples, the non-contact boring system 100 is configured to autonomously or semi-autonomously excavate vertical or substantially vertical bores, shafts, or tunnels through various geologies while increasing efficiencies in boring rate and power (fuel, electricity, combustible gases) consumption. Generally, the non-contact boring system 100 can include one or more non-contact boring elements that direct energy (e.g., through high temperatures, pressures, electromagnetic radiation, etc.) at the bore face to remove material from the bore face through fracture, spallation, and removal of the material.

In order to operate in an autonomous or substantially autonomous manner, the non-contact boring system 100 can automatically execute Blocks of method 1100 to control a set of boring parameters (electrical power, gas flow, air flow, fuel flow, etc.) that affect the flux of energy directed at the bore face. Moreover, the non-contact boring system 100 can automatically execute Blocks of method 1100 to: monitor, direct, maintain, and/or adjust a set of boring controls including, for example, a standoff distance between the non-contact boring system 100 and the bore face, a depth positioning of the system within the bore, a removal rate of material from the bore face, a spall size of the spallation process at the bore face, and/or a thermal or topological characterization of the bore face during boring operations.

A challenge in vertical boring operations is the removal of material from the bore face to an above-grade location. As the depth of the bore increases, the amount of work required to lift the excavated material to the surface also increases. Accordingly, the non-contact boring system 100 can: monitor and characterize rock geology being bored in real-time or substantially real-time; determine a spall size for the spall created at the bore face; adjust a set of boring parameters to maintain a target spall size for a given geology; and adjust or optimize an exhaust rate of an exhaust system to ensure efficient and complete removal of the spall from the bore during and/or after boring operations.

In some (vertical boring) examples, the non-contact boring system 100 is configured to fracture and disintegrate rock (and soil, etc.) at the bore face before these materials melt. By fracturing material at the face of the bore rather than melting this material, the real-time or substantially real-time can remove less complex spoil (e.g., gas and solid rock spall only rather than gas, spall, and lava) with less heat, which may extend the operating life of components of the system 100, reduce energy consumption per unit depth (or volume) bored, and reduce overall expenses associated with boring operations through increased efficiency and longevity of the system 100.

In some (vertical boring) examples, the non-contact boring system 100 is configured to autonomously or semi-autonomously bore shafts, pits, or tunnels in a vertical orientation. The system 100 can be employed in vertical boring operations in any application requiring vertically oriented bores, including for example: urban/rural infrastructure, construction, telecommunications, well drilling, mineral extraction, resource extraction, geothermal energy tapping, and/or scientific research or experimentation. The non-contact boring system 100 can be readily deployed in austere or remote environments requiring minimal human supervision and in a variety of locations ranging from flat ground to rugged, sloping, or uneven terrain.

### Boring Initialization Examples

To initiate a boring operation, the non-contact boring system 100 is located at a bore entry. For example, for a vertical boring operation, a ground opening (or “launch shaft”) is dug (e.g., manually) at a start depth of the bore and at a width and length sufficient to accommodate the non-contact boring system 100 in a vertical orientation. With the non-contact boring system 100 located at the bore entry and the non-contact boring element 105 adjacent a bore face 142, the controller can: implement methods and techniques described below to: position the non-contact boring element 105 to a target standoff distance from the bore face 142 and generate a target spall size; actuate the non-contact boring element 105 to remove material from the bore face 142 through heating and spallation; and actuate the driver 906 to advance the boring rig to a second position at the target standoff distance. As described below, the controller 150 can implement closed-loop controls to maintain the target standoff distance and target spall size and to autonomously or semi-autonomously position the chassis 160 within the bore.

### Surface Rig Examples

As shown in FIG. 10, the non-contact boring system 100 can include a surface rig 900 arranged on a surface including: a connector 902 connecting the surface rig 900 to the chassis 160 and a driver 906 coupled to the connector 902 and configured to position the chassis 160 along an axis (e.g., a vertical or substantially vertical axis relative to the surface). The connector 902 and the driver 906 can cooperatively function to position the chassis 160 and the non-contact boring element 105 at a target standoff distance from the bore face 142 during boring operations. The surface rig 900 can include a set of legs 970 (which may be also referred to as risers) that elevate the driver 906 over the bore hole and provide sufficient space for inlet and exhaust conduits to ingress or regress from the bore during operation. In some examples, the set of legs 970 can be distributed about the periphery of the surface rig 900 and have adjustable lengths such that the surface rig 900 can be leveled over uneven surface terrain, thereby permitting smooth operation of the driver 906 during operation. Alternatively, the set of legs 970 can be of uniform length and the driver 906 can be mounted on a gimbal or swivel that permits the driver 906 to extend the connector 902 in a uniformly vertical direction.

As shown in FIG. 10, the non-contact boring system 100 can also include an umbilical cord 190 arranged between the chassis 160 and the surface and configured to house an umbilical cord 190 to provide power, air, fuel, combustible gas, etcetera, to the non-contact boring element 105. For example, in some examples, the non-contact boring element 105 can include a plasma torch. Accordingly, the umbilical cord 190 can contain and direct electrical power and gas lines to feed the plasma torch during operation. In the same or other examples, the non-contact boring element 105 can include a jet engine. Accordingly, the umbilical cord 190 can contain and direct a fresh air conduit and a fuel line (e.g., diesel or jet fuel) to drive the jet engine during boring operation. In the same or other examples, the non-contact boring element 105 can include a set of effectors of the type described herein, and the umbilical cord 190 can contain and direct a corresponding set of inputs to the respective non-boring elements.

As shown in FIG. 10, the non-contact boring system 100 can also include an additional extensible coupling 930 arranged between the chassis 160 and the surface rig and configured to transfer boring ejecta from a bore face 142 to the surface. During boring operations, the non-contact boring element 105 is arranged at a target standoff distance from the bore face 142 and, through non-contact transfer of energy and pressure, causes the geology to fracture and produce spall. The additional extensible coupling 930 functions to remove the ejected spall from near the bore face 142 to a distal location at or near the surface. In order to draw the spall from the bore face 142, the non-contact boring system 100 can also include an exhaust 940 connected to the additional extensible coupling 930 and configured to draw boring ejecta through the additional extensible coupling 930. The exhaust 940 can include a vacuum pump, turbine, or jet engine configured to generate a negative air pressure at the surface and draw spall upward along the bore and out of the boring path of the system 100.

For example, the exhaust 940 can include a vacuum pump that is configured to apply a negative pressure at the additional extensible coupling 930 at or near the surface. The exhaust 940 can be configured to operate at a nominal or static negative pressure independent of the boring depth. Alternatively, the exhaust 940 can be configured to vary or adapt the negative pressure applied at the additional extensible coupling 930 in response to the depth of the chassis 160. Generally, as the depth of the chassis 160 increases, the exhaust 940 can apply more negative pressure at the surface to overcome the amount of work required to move the spall over a greater distance against the force of gravity. Conversely, when the chassis 160 is located at a relatively shallow depth, the exhaust 940 can apply less negative pressure in response to the lesser work requirement of lifting the spall from the bore face 142 to the surface.

In some examples, the non-contact boring system 100 comprises a filter 950 arranged between the exhaust 940 and the additional extensible coupling 930 to collect the spall and prevent ingestion of the spall into the exhaust 940. Alternatively, a series set of interchangeable filters 950 can be arranged between the exhaust 940 and the additional extensible coupling 930 to permit filter exchanging, cleaning, and spall sampling, conducted autonomously by the system 100 or semi-autonomously with an operator of the system 100. Additionally, or alternatively, the filter 950 can be non-homogenous or graded such that it collects certain sizes of spall along an axis arranged substantially parallel to the flow of spall to exhaust 940. For example, the filter 950 can be configured to have a decreasing pore size along the air flow such that larger particulate is filtered at a location proximate to the additional extensible coupling 930 and smaller particulate is filtered at a location proximate to the exhaust 940. Accordingly, the filter 950 can further function as a proxy for spall size, spall quality, and material classification as described in detail below.

### Controller Examples

As shown in FIGS. 9 and 10, the non-contact boring system 100 can also include a controller 150 connected to the non-contact boring element 105, the boring-element actuator 107, the driver 906, and the exhaust 940. The controller 150 can function to: direct the driver 906 to position the non-contact boring element 105 at a target standoff distance; monitor a set of boring parameters associated with the non-contact boring element 105; direct the exhaust 940 to draw boring ejecta through the second extensible coupling at a target exhaust rate; and characterize a boring rate in response to a spall size of the spall generated at the bore face 142 during boring operations. The controller 150 can be arranged in the chassis 160 and proximate the boring-element actuator 107 and the non-contact boring element 105 and communicate with the driver 906 and the exhaust 940. Alternatively, the controller 150 can be arranged in or adjacent to the driver 906 and in communication with the boring-element actuator 107, the non-contact boring element 105, and the exhaust 940. In some examples, the controller 150 can include a set of controllers distributed throughout the non-contact boring system 100 (e.g., at the chassis 160, at the driver 906, and/or at the exhaust 940) and communicable within the non-contact boring system 100 to implement closed-loop controls during boring operations as described below.

### Above Surface Control Examples

In some (vertical boring) examples, the non-contact boring system 100 comprises an analyzer 960 connected to the controller and configured to: determine a characteristic of a bore face material based upon a composition of the boring ejecta; and measure the spall size of the spall generated at the bore face 142 during operation. Additionally, or alternatively, the analyzer 26o can be configured to characterize spall quality (e.g., size, shape) and/or spall material (granite, limestone, silica, etc.). In some examples, the analyzer 960 can access or retrieve spall material from the filter 950 (or a filter 950 in a set of filters 950) in real-time or near real-time such that the analyzer 960 can: characterize a current or near current state of the geology during boring operations; and provide the geological characterization to the controller 150 to maintain or adjust a boring parameter in response to the geological characterization.

In operation, the analyzer 960 can access a spoil sample from the filter 950 of a set of filters 950 that corresponds to a particular boring depth through automated chemical extraction of the particulate or automated chemical decomposition or dissolution of the surrounding filter material. The analyzer 960 can provide higher fidelity information regarding the composition of the bore face 142 for each filter 950 in the set of filters 950. For example, the onsite analyzer can include an x-ray diffraction (XRD) analyzer, a laser-induced breakdown spectroscopy (LIBS) analyzer, a laser-induced fluorescence (LIF) analyzer, a Raman spectrometer, or a mass spectrometer. The non-contact boring system 100 can use a subset of the analyzers to determine a higher fidelity understanding of the chemical composition of the bore face 142 corresponding to each boring log.

For example, the analyzer 960 can access a spoil sample from the filter 950 at a first time T1 corresponding to a particular filter 950 in a set of filters 950, and corresponding to a depth of the bore and a set of boring parameters implemented by the controller 150. The analyzer 960 can then: characterize a spall quality at time T1 by measuring a ratio of small particulate spall to large particulate spall within the filter 950; and characterize a geology of the bore face 142 at time T1 by analyzing the mineralogical content of the spall ejecta collected in the filter 950. The analyzer 960 can be further configured to transmit the spall quality and the bore face 142 geology characterizations to the controller 150 so that the controller 150 can implement closed-loop controls to maintain or adjust a set of boring parameters (e.g., air/fuel mixture, gas flow rate, electrical power, stand-off distance, dwell time, raster rate, etcetera) at the bore face 142 to maintain or improve boring efficiency.

### Down Hole Analysis

In some (vertical boring) examples, the non-contact boring system 100 comprises a set of sensors 198 (e.g., optical sensors) connected to the controller 150 and arranged on the chassis facing the bore face 142. Additionally, or alternatively, the non-contact boring system 100 can include a set of optical sensors arranged on non-leading edges of the chassis 160, for example facing toward the sides of the bore or towards the surface. The controller 150 can access or receive images from the set of optical sensors to map a temperature profile at the bore face 142 and/or characterize a real-time spall size of material emitted from the bore face 142 during operation. In response to the temperature profile and/or the spall size characterization, the controller 150 can then implement closed-loop controls to maintain or adjust a set of boring parameters.

For example, the non-contact boring system 100 comprises a thermally-shielded sensor housing; a thermally-shielded window (e.g., a louvered shutter) arranged across an opening in the sensor housing; and a 2D optical sensor arranged in the sensor housing behind the window. For example, the optical sensor can include: an infrared thermal camera; a color (e.g., RGB) camera; or an array of infrared or laser single-point temperature sensors, each representing a “pixel.”

In some examples, during an imaging cycle, the controller 150 can: trigger the window to open; trigger the optical sensor to capture a burst of images of the bore face 142 (e.g., 30 images over a half-second imaging cycle); and then close the window to shield the optical sensor from excess heat output and/or spall ejecta and enable the optical sensor to cool and/or recalibrate in preparation for a next imaging cycle. For example, the controller 150 can intermittently trigger the optical sensor to execute an imaging cycle, such as once per five-second interval or at a 10% duty.

Alternatively, the non-contact boring system 100 can include a temperature sensor within the sensor housing. During operation, the controller 150 can: regularly sample this temperature sensor; open the window and trigger the optical sensor to capture images while the temperature in the housing is within an operating temperature range; and close the window and cease operation of the optical sensor when the temperature in the housing exceeds this operating temperature range.

Additionally, or alternatively, the non-contact boring system 100 can include a lens shade – such as a fixed or adjustable UV, infrared, and/or visible light filter – arranged across the field of view of the optical sensor. In particular, the lens shade can be configured to prevent overexposure of images captured by the optical sensor and thus enable the controller 150 to capture rich optical data of the bore face 142, interpret conditions at the bore face 142, and characteristics of spall fragments from these optical data, and maintain or adjust one or more boring parameters in real-time during operation based on these bore face conditions and spall fragment characteristics.

Once located in the bore and activated, the controller 150 can: execute imaging cycles; and detect and track temperatures, temperature profiles, and/or molten areas of the bore face 142 based on intransient features (e.g., features exhibiting significant change over a relatively long time scales, such as greater than one second) detected in images captured by the optical sensor; and then adjust boring parameters based on these features to maintain or increase material removal rate from the bore.

In some examples, a target spall size can be specified based on the type and/or density of actual or predicted geologies at the bore face 142. For example, the controller 150 can select a smaller target spall size for higher-density geologies and/or for geologies with higher heat capacities, thereby enabling the surface temperature of resulting spall fragments to drop below a threshold temperature within a threshold distance behind the chassis 160 and thus reducing thermal management and shielding requirements beyond this threshold distance behind the chassis 160. Accordingly, the controller 150 can also limit the maximum mass of these spall fragments, thereby enabling the spoil evacuation subsystem to draw heated spall fragments – moving off of the bore face 142 – at least a minimum distance behind the chassis 160 before these spall fragments are ingested into the additional extensible coupling 930.

Conversely, the controller 150 can select a larger target spall size for lower-density geologies and/or for geologies with lower heat capacities, thereby preventing these spall fragments from rapidly condensing and adhering to the chassis or the wall of the bore; and enabling the system 100 to increase boring rate with less energy consumption per unit bore depth. Furthermore, by maintaining a tight distribution of spall fragment size, the controller 150 may eliminate the need for spoil sorting, filtering, crushing, or other post-processing once removed from the bore.

In some examples, the controller 150 can: (a) trigger the optical sensor to capture a first image; (b) scan the first image for saturated pixel clusters; and (c) compare saturated pixel clusters in this first image to saturated pixel clusters in preceding images to identify and isolate (e.g., extract) moving (e.g., short-time domain) saturated pixel clusters – which may represent spall and other particulate moving through the working field – in the current image.

The controller 150 can then derive spall characteristics for a first-time interval corresponding to a first image based on these moving saturated pixel clusters. For example, the controller 150 can estimate a quantity, a maximum size (e.g., width, area), a minimum size, an average size, a size variance, and/or a size distribution (e.g., a histogram) of spall fragments during this first-time interval based on the widths, radii, and/or pixel areas of these saturated pixel clusters.

As shown in FIGS. 9 and 10, the non-contact boring system 100 can include a set of offset optical sensors. Accordingly, the controller 150 can be configured to implement 3D reconstruction techniques to merge concurrent images from a set of optical sensors into a 3D thermal image; implement similar methods and techniques to detect and isolate moving saturated 3D volumes in the 3D thermal image; then derive spall characteristics for the current time interval based on radii and/or volumes of these moving saturated 3D volumes. In operation, the controller 150 can repeat this process to derive spall characteristics for subsequent time intervals based on subsequent images captured by the optical sensor(s).

### Examples of Closed-Loop Controls

In some examples, the controller 150 accesses a target spall size, such as entered manually by an operator and stored in local memory in the system 100 or calculated by the controller 150 based on a detected or predicted geology at the bore face 142. The controller 150 can access detected spall size through above-grade spall analysis by the analyzer 960 and/or through local imaging by the set of optical sensors. The controller 150 can then implement closed-loop controls to adjust boring parameters in order to maintain a target spall fragment size and low spall fragment size variance.

For example, if a detected average spall fragment size is less than the target spall fragment size, the controller 150 can adjust a set of boring parameters (e.g., increased temperature, afterburner actuation, decreased standoff distance) in order to increase pressure at the bore face 142, which may induce greater fracture and spallation of larger spall fragment from the bore face. Conversely, if the imaged average spall fragment size is greater than the target spall fragment size, the controller 150 can adjust a set of boring parameters (e.g., decreased temperature, increased standoff distance) in order to decrease pressure and increase energy at the bore face 142, which may reduce fracturing and increase melting to create smaller spall fragments.

In another example, if detected spall fragment size exhibits high variance or a wide size distribution, the controller 150 can: adjust one or more boring parameters to decrease energy at the bore face 142; and decrease standoff distance in order to focus energy to a smaller region of the bore face 142 and thus reduce size variance of spall fragments ejected from this region of the bore face 142; and actuate the boring-element actuator 107 to sweep (i.e., pitch and/or yaw) the non-contact boring element 105 across the bore face 142 in order to energize and remove low-variance spall fragments from these regions of the bore face 142. Then, as the size variance of spall fragments decreases over time, the controller 150 can incrementally adjust one or more boring parameters in order to increase the removal rate while maintaining low spall fragment size variance around the target spall size.

In another example, if the maximum spall fragment size exceeds the target spall fragment size, the controller 150 can: predict loose geology (e.g., silt, gravel) or a geology with low structural integrity (e.g., fractured limestone) at the bore face 142; and adjust one or more boring parameters in order to increase pressure but reduce energy across the bore face 142, thereby increasing probability of fracturing (or melting) loose geology into smaller fragments. Conversely, if the maximum spall fragment size exceeds the target spall fragment size, the controller 150 can: predict resilient geology (e.g., granite) or geology with high structural integrity (e.g., a boulder); and adjust a set of boring parameters in order to decrease pressure but increase energy across the bore face 142, thereby reducing fracturing and increasing spall size.

In some examples, the controller 150 is connected to the exhaust 940. Accordingly, the controller 150 can further implement closed-loop controls to: direct the exhaust 940 to maintain or adjust a negative pressure at the surface to extract spall generated at the bore face 142 in response to a detected spall size. In the same or other examples, the controller 150 can: receive a measurement of a spall size from the analyzer 960 or the set of optical sensors; maintain or adjust a set of boring parameters at the bore face 142 in response to the spall size; and maintain or adjust an exhaust pressure at the exhaust 940 in response to the spall size. For example, if a set of images captured by the set of optical sensors (or an analysis of the filter 950 by the analyzer 960) indicates that the spall size is above the target spall size, the controller 150 can implement the closed-loop controls described above to achieve a smaller spall size at the bore face 142 and/or increase a negative exhaust pressure at the exhaust 940 to provide more force to remove the larger and heavier spall from the bore face 142. Conversely, if a set of images captured by the set of optical sensors (or an analysis of the filter 950 by the analyzer 960) indicates that the spall size is below the target spall size, the controller 150 can implement the closed-loop controls described above to achieve a larger spall size at the bore face 142 and/or decrease a negative exhaust pressure at the exhaust 940 to provide a minimally effective force to remove the smaller and lighter spall from the bore face 142. In another example operation, if a set of images captured by the set of optical sensors (or an analysis of the filter 950 by the analyzer 960) indicates that the spall size is within the target spall size, the controller 150 can implement the closed-loop controls described above to maintain a current boring rate at the bore face 142 and/or maintain the current negative exhaust pressure at the exhaust 940 to provide a currently efficient force to remove the spall from the bore face 142.

### Examples of Boring Termination and Extraction

Upon reaching a bore termination depth, the boring operation can be terminated and the system 100 can be removed from the bore. For example, the umbilical cord 190 and the additional extensible coupling 930 can be extracted from the bore, while maintaining power connectivity with the controller 150 and the chassis 160. The controller 150 can then direct the driver 906 to retract the chassis 160 from the bore face 142 to an above grade location at which time the chassis 160 can be removed from the connector 902 and the system 100 can be disassembled.

Alternatively, the umbilical cord 190 and the additional extensible coupling 930 can be collapsible in the direction opposite their relative extension. In some examples, the controller 150 can direct the driver 906 to retract the chassis 160 from the bore face 142 and the chassis 160 can lift and collapse the umbilical cord 190 and the additional extensible coupling 930 as the driver 906 is lifting the chassis 160 from the bore face 142.

In some examples, the umbilical cord 190 and the additional extensible coupling 930 can be connected such that the umbilical cord 190 is disposed directly adjacent to (or within) the additional extensible coupling 930. For example, the umbilical cord 190 can be arranged inside the interior volume of the additional extensible coupling 930, along an interior surface and defining a distinct and separate volume to deliver boring parameter inputs (e.g., fresh air, electrical power, fuel, combustible gas, etcetera) to the chassis 160. Accordingly, upon boring termination, the controller 150 can direct the driver 906 to retract the chassis 160 from the bore face 142 and the chassis 160 can lift and collapse the umbilical cord 190 and the additional extensible coupling 930 as the driver 906 is lifting the chassis 160 from the bore face 142.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A system to form a bore selected from the group consisting of an underground tunnel, a trench, and a vertical shaft, the system comprising:
a chassis;
a propulsion subsystem configured to advance the chassis forward through the underground bore; and
a non-contact boring element, wherein:
the non-contact boring element is selected from the group consisting of a plasma torch, a jet engine, or a flame jet,
the non-contact boring element is mounted to the chassis,
the non-contact boring element is configured to exhaust high-temperature, high-mass-flowrate exhaust gases toward a face of an underground bore such that these high-temperature, high-mass-flowrate exhaust gases, upon reaching the bore face within a jet impingement area, are able to thermally shock geologies at the bore face thus leading to spallation of the geologies and removal of the geologies in a form of a rock spall from the bore face.

2. The system of claim 1, wherein the non-contact boring element is a combustor selected from the group consisting of the jet engine and the flame jet.

3. The system of claim 1, wherein the non-contact boring element is the jet engine further configured:
to compress fresh air from an above-ground air supply within a compressor, to mix this compressed air with fuel from an above-ground fuel source,
to combust this mixture, and
to extract some energy from these combustion products to drive the compressor.

4. The system of claim 3, wherein the jet engine is a Brayton-cycle turbojet engine.

5. The system of claim 3, further comprising an air supply line configured to supply the fresh air from the above-ground air supply to the compressor, wherein the air supply line comprises a flexible duct hose and heat shielding over a section of the flexible duct hose immediately trailing the jet engine.

6. The system of claim 3, further comprising a fuel supply line configured to supply the fuel from the above-ground fuel source to the jet engine, wherein the fuel supply line is positioned to be heated by exhaust gases moving rearward from the bore face such that the fuel is heated before reaching the jet engine.

7. The system of claim 3, further comprising a fuel pump configured to draw the fuel from the above-ground fuel source through a fuel supply line.

8. The system of claim 3, further comprising a compressor tap arranged between the compressor and a combustor of the jet engine, and a low-temperature jet coupled to the compressor tap and configured to direct compressed air toward spall removed from the bore face to move the spall rearward from the bore face.

9. The system of claim 3, further comprising a fan driven by a turbine of the jet engine and configured to output a stream of low-temperature compressed air separate from the high-temperature, high-mass-flowrate exhaust gases.

10. The system of claim 1, further comprising a compressor for supplying compressed air to the non-contact boring element, wherein the non-contact boring element is the flame jet.

11. The system of claim 1, wherein the propulsion subsystem comprises one of driven wheels or tracks.

12. The system of claim 1, wherein:
the bore is the vertical shaft, and
the propulsion subsystem is a driver positioned outside of the bore and connected to the non-contact boring element by a connector.

13. The system of claim 1, wherein the bore is the trench.

14. The system of claim 13, further comprising a spall shroud coupled to the chassis and configured to retain and direct spall fragments to a location adjacent to the trench.

15. The system of claim 13, further comprising a set of depth sensors configured to measure a trench profile, wherein a controller is configured to adjust at least one of a standoff distance, an approach angle, or a trenching parameter based on the measured trench profile.

16. The system of claim 1, further comprising a boring-element actuator connecting the non-contact boring element to the chassis and configured to perform one or more of:
to locate the non-contact boring element on the chassis,
to advance and retract the non-contact boring element longitudinally along the chassis to maintain a standoff distance between the non-contact boring element and the bore face, and
to pitch and yaw the non-contact boring element on the chassis to scan the jet impingement area across the bore face.

17. The system of claim 1, further comprising a temperature sensor configured to measure a temperature of the high-temperature, high-mass-flowrate exhaust gases exiting the non-contact boring element, and a controller configured to regulate a rate of fuel supplied to the non-contact boring element based on the measured temperature.

18. The system of claim 17, wherein the controller is configured to set a target exhaust gas temperature based on a detected geology at the bore face.

19. The system of claim 1, wherein the non-contact boring element comprises a nozzle configured to direct the high-temperature, high-mass-flowrate exhaust gases toward the bore face to form the jet impingement area at a target standoff distance from the bore face.

20. The system of claim 1, further comprising a bore face detector configured to detect electromagnetic signals emitted from the bore face during operation of the non-contact boring element.
